(19) United States
(12) Patent Application Publication
(10) Pub. No.: US 2007/0054805 A1
(43) Pub. Date: Mar. 8, 2007

(54) Novel sulfonamide-comprising solid formulations

(75) Inventors: Hans-Peter Krause, Hofheim (DE); Gerhard Schnabel, Elsenfeld (DE); Ralph Grohs, Dusseldorf (DE)

Correspondence Address: STERNE, KESSLER, GOLDSTEIN & FOX PLLC, 1100 NEW YORK AVENUE, N.W., WASHINGTON, DC, 20005, US

(73) Assignee: BAYER CROPSCIENCE GMBH, Frankfurt (DE)

(21) Appl. No.: 11/515,830

(22) Filed: Sep. 6, 2006

(30) Foreign Application Priority Data
Sep. 8, 2005 (EP) EP 05019531.2
Mar. 25, 2006 (EP) EP 06006195.9
Mar. 25, 2006 (EP) EP 06006194.2

(51) Int. Cl. A01N 25/00

(52) U.S. Cl. 504/102

(57) ABSTRACT

The present invention relates to solid water-dispersible formulation comprising one or more herbicidally active compounds from the group of the sulfonamides of the formula (I) and their salts, one or more safeners, one or more solvents, one or more carrier materials selected from carriers having low and/or high absorbency, one or more customary auxiliaries and additives, selected from emulsifiers, antifoams, wetting agents and dispersants; where the safeners and solvents are in a particular ratio, and these two components together are also in a particular ratio to the carriers having high absorbency used. The formulations according to the invention are suitable for use in crop protection.

The present invention relates to the field of crop protection compositions. In particular, the invention relates to solid herbicide formulations which comprise herbicidally active compounds from the group of the sulfonamides and their salts, in particular phenylsulfonamides, such as phenylsulfonylaminocarbonyltriazolinones or phenylsulfonylureas and heteroarylsulfonamides and their salts.

In general, active compounds for crop protection are not employed in pure form. Depending on the area of use and the type of use, and on physical, chemical and biological parameters, the active compound is used as an active compound formulation in a mixture with customary auxiliaries and additives. However, the active compound formulation of combinations with further active compounds for widening the activity spectrum and/or for protecting crop plants (for example by safeners, antidotes) is an important field of formulation technology, since active compounds having in some cases quite different physical, chemical and biological parameters have to be formulated together in an adequate manner here.

Thus, formulations of active compounds, alone or in combinations of several active compounds, for crop protection should generally have high chemical and physical stability, should be easy to apply and easy to use and have broad biological action combined with high selectivity with respect to the active compounds used, and should additionally be easy to formulate in the preparation process.

Solid formulations of active compounds from the group of the sulfonylureas are known per se, for example from WO-A-97/10714.

However, with respect to a sufficiently satisfactory applicability, there are currently no satisfactory active compound-comprising solid formulations of combinations of the sulfonamides with further active compounds, such as, for example, safeners having a low melting point. In this context, in most cases it is observed that the solid formulation composed in this manner is poorly dispersible when aqueous spray liquors are prepared, resulting, for example, in blocked nozzles during application and activity losses after application.

In addition, herbicidally active compounds from the group of the sulfonamides generally have high chemical reactivity and tend to undergo chemical degradation, for example by hydrolysis which has to be judged critical with respect to a sufficient storage stability of the formulations.

A stabilization of sulfonylureas comprised in solid formulations is described, for example, in JP-A-62-084004, where calcium carbonate and Na tripolyphosphate are added as stabilizers. However, in addition the formulations for their part, owing to the auxiliaries and additives comprised therein, may also affect the stability of the active compounds: WO-A-98/34482 describes results of tests with the phenylsulfonylureas tritosulfuron and metsulfuron according to which additives (adjuvants) from the group of the fatty alcohol ethoxylates and the ethoxylated fatty amines result in lower storage stability than adjuvants from the group of the sodium salts of the aliphatic sulfonic acids, such as Na alkanesulfonates and Na alpha-olefinsulfonates. EP-A-764404 describes a stabilization of the heteroarylsulfonylurea flazasulfuron using Na dioctylsulfosuccinate.

Corresponding stability studies with active compounds from the group of the sulfonamides of the formula (I) and their salts in combination with safeners and solvents formulated as granules are not known.

It was an object of the present invention to provide an improved solid formulation containing crop protection agents, which is composed of combinations of active compounds from the group of the sulfonamides and active compounds from the group of the safeners and which has good applicability at unchanged high biological effectiveness and crop plant compatibility of the active compounds. In addition, these active compound combinations should have high physical and chemical storage stability in the formulation, they should additionally be easy to formulate in the preparation process of the formulation, and they should also later be user friendly.

This object is achieved by the solid water-dispersible formulation according to the present invention.

Accordingly, the present invention relates to a solid water-dispersible formulation comprising:
(a) one or more active compounds from the group of the sulfonamides of the formula (I) and their salts;
(b) one or more safeners;
(c) one or more solvents;
(d) one or more carrier materials, selected from one or more of the following groups:
   (d-1) carriers with low absorbency,
   (d-2) carriers with high absorbency;
(e) one or more customary auxiliaries and additives, selected from one or more of the following groups
   (e-1) emulsifiers,
   (e-2) antifoams,
   (e-3) wetting agents,
   (e-4) dispersants;
      where
      component (b) to component (c) is in the following ratio: (b):(c) in general from 0.3 to 2.0:1, preferably from 0.4 to 1.5:1, particularly preferably from 0.5 to 1.0:1; and
      where at the same time the sum of components (b) and (c) to component (d-2) is in the following ratio: [(b)+(c)]:(d-2) in general from 1.7 to 3.9:1, preferably from 1.85 to 3.5:1, particularly preferably from 2.0 to 3.0:1.

In addition, the solid water-dispersible formulation according to the invention may, as further components, optionally also comprise:
(f) one or more agrochemically active compounds different from the components (a) and (b);
(g) one or more further customary auxiliaries and additives different from components (e).

The sulfonamides in question (component a) are characterized by the formula (I):
R^{α}-(A)ₘ-SO₂—NR^{β}—CO—(NR^{γ})ₙ—R^{δ} (I)
in which
R^{α} is an unsubstituted or substituted heteroaryl radical, where the phenyl radical including substituents has 1-30 carbon atoms, preferably 1-20 carbon atoms, or
is an unsubstituted or substituted phenyl radical, where the phenyl radical including substituents has 6-30 carbon atoms, preferably 6-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably 0,
m is zero or 1,
n is zero or 1, preferably 1, and
R^{δ} is a heterocyclic radical, such as a pyrimidinyl radical or a triazinyl radical.

The formula (I) mentioned above is defined more accurately by the formulae (I)-1 to (I)-6 below, excluding representatives from the group of the phenylsulfonylureas such as iodosulfuron-methyl and mesosulfuron-methyl and from the group of the other sulfonamides such as amidosulfuron.

Preferred sulfonamides of the formula (I) (component a) are phenylsulfonamides, such as phenylsulfonylureas, and heteroarylsulfonamides, and also their salts. Preferred phenylsulfonamides are compounds from the group of the phenylsulfonylureas. The term phenylsulfonylureas is to be understood as including sulfonylureas where the phenyl group is attached via a spacer such as CH₂, O or NH to the sulfone group (SO₂).

Suitable phenylsulfonamides are for example phenylsulfonamides of the formula (I)-1 and/or salts thereof,
R^{α}-(A)ₘ-SO₂—NR^{β}—CO—(NR^{γ})ₙ—R^{δ} (I)-1
in which
R^{α} is an unsubstituted or substituted phenyl radical, where the phenyl radical including substituents has 6-30 carbon atoms, preferably 6-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably 0,
m is zero or 1,
n is zero or 1, preferably 1, and
R^{δ} is a heterocyclic radical, such as a pyrimidinyl radical or a triazinyl radical.

Preferred phenylsulfonamides are phenylsulfonylureas, for example phenylsulfonylureas of the formula (I)-2 and/or salts thereof,
R^{α}-(A)ₘ-SO₂—NR^{β}—CO—NR^{γ}—R^{δ} (I)-2
in which
R^{α} is an unsubstituted or substituted phenyl radical, where the phenyl radical including substituents has 6-30 carbon atoms, preferably 6-20 carbon atoms,
R^{β} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A is CH₂, O or NH, preferably 0,
m is zero or 1, and
R^{δ} is a heterocyclic radical, such as a pyrimidinyl radical or a triazinyl radical.

Preference is given to phenylsulfonylureas of the formula (I)-3 and/or salts thereof, 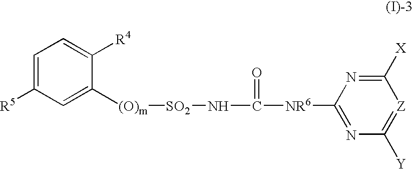
in which
R⁴ is C₁-C₄-alkoxy, preferably C₂-C₄-alkoxy, or CO—R^{a}, where R^{a} is OH, C₁-C₄-alkoxy or NR^{b}R^{c}, where R^{b} and R^{c} are identical or different and independently of one another are H or C₁-C₄-alkyl,
R⁵ is H, halogen (F, Cl, Br) or —NR^{d}R^{e}, R^{d} is H or C₁-C₄-alkyl and R^{e} is an acyl radical, such as formyl, or C₁-C₄-alkylsulfonyl,
R⁶ is H or C₁-C₄-alkyl,
m is zero or 1,
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight last-mentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy, and
Z is CH or N.

Particular preference is given to phenylsulfonylureas of the formula (I)-3 and/or salts thereof, in which
a) R⁴ is CO—(C₁-C₄-alkoxy), R⁵ is halogen (F, Cl, Br), or R⁵ is —NHR^{e}, where R^{e} is an acyl radical, preferably C₁-C₄-alkylsulfonyl, and m is zero,
b) R⁴ is CO—N(C₁-C₄-alkyl)₂, R⁵ is NHR^{e}, where R^{e} is an acyl radical, preferably formyl, and m is zero, or
c) R⁴ is C₂-C₄-alkoxy, R⁵ is H and m is 1.

Typical phenylsulfonylureas are, inter alia, the compounds listed below and their salts, such as the sodium salts: bensulfuron-methyl, chlorimuron-ethyl, chlorsulfuron, cinosulfuron, cyclosulfamuron, ethametsulfuron-methyl, ethoxysulfuron and its sodium salt, metsulfuron-methyl, oxasulfuron, primisulfuron-methyl, prosulfuron, sulfometuron-methyl, triasulfuron, tribenuron-methyl, triflusulfuron-methyl, tritosulfuron and foramsulfuron and its sodium salt (Agrow No. 338, Oct. 15, 1999, page 26 (PJB Publications Ltd. 1999)).

Particularly preferred phenylsulfonamides are: foramsulfuron and its sodium salt, methyl 4-[(4,5-dihydro-3-methoxy-4-methyl-5-oxo-1H-1,2,4-triazol-1-yl)carboxamidosulfonyl]-5-methylthiophene-3-carboxylate and its sodium salt, and ethoxysulfuron and its sodium salt, metsulfuron-methyl and its sodium salt, tribenuron-methyl and its sodium salt, chlorsulfuron and its sodium salt.

The active compounds listed above are known, for example, from “The Pesticide Manual”, 12th edition, The British Crop Protection Council (2000), or the literature references given after the individual active compounds.

Suitable heteroarylsulfonamides are, for example, compounds from the group of the heteroarylsulfonylureas. The term “heteroarylsulfonylureas” is to be understood as including those sulfonylureas in which the heteroaryl group is attached via a spacer such as CH₂, O or NH to the sulfone group (SO₂).

Suitable heteroarylsulfonamides are, for example, sulfonamides of the formula (I)-4 and/or salts thereof,
R^{α′}-(A′)_{m′}—SO₂—NR^{β′}—CO—(NR^{γ′})_{n′}—R^{δ′} (I)-4
in which
R^{α′} is an unsubstituted or substituted heteroaryl radical, where the heteroaryl radical including substituents has 1-30 carbon atoms, preferably 1-20 carbon atoms,
R^{β′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1,
n′ is zero or 1, preferably 1, and
R^{δ′} is a heterocyclic radical, such as a pyrimidinyl radical or a triazinyl radical.

Preferred heteroarylsulfonamides are heteroarylsulfonylureas, for example sulfonylureas of the formula (I)-5 and/or salts thereof,
R^{α′}-(A′)_{m′}-SO₂—NR^{β′}—CO—NR^{γ′}—R^{δ′} (I)-5
in which
R^{α′} is an unsubstituted or substituted heteroaryl radical, where the heteroaryl radical including substituents has 1-30 carbon atoms, preferably 1-20 carbon atoms,
R^{β′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
R^{γ′} is a hydrogen atom or an unsubstituted or substituted hydrocarbon radical which, including substituents, has 1-10 carbon atoms, for example unsubstituted or substituted C₁-C₆-alkyl, preferably a hydrogen atom or methyl,
A′ is CH₂, O or NH, preferably O,
m′ is zero or 1, and
R^{δ′} is a heterocyclic radical, such as a pyrimidinyl radical or a triazinyl radical.

Particular preference is given to heteroarylsulfonamides of the formula (I)-6 below,
R^{α′}—SO₂—NH—CO—(NR^{γ′})_{n′}—R^{δ′} (I)-6
in which
R^{α′} is a substituted heteroaryl radical such as substituted pyridyl, thienyl, pyrazolyl or imidazolyl,
R^{γ′} is H, (C₁-C₃)-alkyl, unsubstituted or substituted by halogen (F, C, Br, I) or halo-(C₁-C₃)-alkoxy, preferably H or methyl,
for n′=1, R^{δ′} is a pyrimidinyl radical or a triazinyl radical, preferably 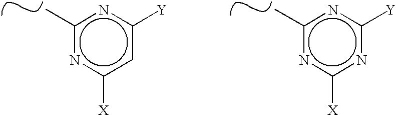
X and Y are identical or different and independently of one another are halogen or NR′R″, where R′ and R″ are identical or different and are H or C₁-C₄-alkyl, or C₁-C₆-alkyl, C₁-C₆-alkoxy, C₁-C₆-alkylthio, C₃-C₆-cycloalkyl, C₂-C₆-alkenyl, C₂-C₆-alkynyl, C₃-C₆-alkenyloxy or C₃-C₆-alkynyloxy, where each of the eight last-mentioned radicals is unsubstituted or substituted by one or more radicals from the group consisting of halogen, C₁-C₄-alkoxy and C₁-C₄-alkylthio, preferably C₁-C₄-alkyl or C₁-C₄-alkoxy.

Particularly preferably, R^{α′} is 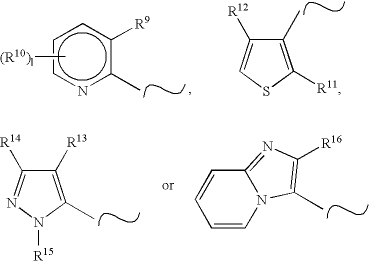
in which
R⁹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, CONR′R″, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl,
R¹⁰ is H, (C₁-C₃)-alkyl, (C₁-C₃)-alkoxy, halo-(C₁-C₃)-alkyl, halo-(C₁-C₃)-alkoxy or halogen (F, Cl, Br, I),
I is zero or 1,
R¹¹ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″,
R¹² is halogen (F, Cl, Br, I), (C₁-C₆)-alkyl, (C₁-C₆)-alkoxy, (C₁-C₆)-alkylsulfonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl,
R¹³ is (C₁-C₆)-alkoxycarbonyl, (C₂-C₆)-alkenyloxycarbonyl, (C₂-C₆)-alkynyloxycarbonyl, (C₁-C₆)-alkyl, (C₁-C₆)-alkoxy, (C₁-C₆)-alkylsulfonyl, halo-(C₁-C₆)-alkoxycarbonyl, halo-(C₂-C₆)-alkenyloxycarbonyl, halo-(C₂-C₆)-alkynyloxycarbonyl, halo-(C₁-C₆)-alkyl, halo-(C₁-C₆)-alkoxy, halo-(C₁-C₆)-alkylsulfonyl, halogen (F, Cl, Br, I), CONR′R″, or R¹³ is a heterocyclic ring, which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen, particularly preferably 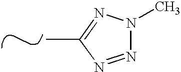
R¹⁴ is H, halogen (F, C, Br, I), (C₁-C₆)-alkyl, halo-(C₁-C₆)-alkyl,
R¹⁵ is H, (C₁-C₆)-alkyl, halo-(C₁-C₆)-alkyl,
R¹⁶ is (C₁-C₆)-alkyl, (C₁-C₆)-alkoxy, (C₂-C₆)-alkenyloxy, (C₂-C₆)-alkynyloxy, (C₁-C₆)-alkylsulfonyl, (C₁-C₆)-alkylcarbonyl, (C₁-C₆)-alkoxycarbonyl, (C₂-C₆)-alkenyloxycarbonyl, (C₂-C₆)-alkynyloxycarbonyl, halo-(C₁-C₆)-alkyl, halo-(C₁-C₆)-alkoxy, halo-(C₂-C₆)-alkenyloxy, halo-(C₂-C₆)-alkynyloxy, halo-(C₁-C₆)-alkylsulfonyl, halo-(C₁-C₆)-alkylcarbonyl, halo-(C₁-C₆)-alkoxycarbonyl, halo-(C₂-C₆)-alkenyloxycarbonyl, halo-(C₂-C₆)-alkynyloxycarbonyl, CONR′R″, in particular SO₂-ethyl, and
R′ and R″ independently of one another are H, (C₁-C₆)-alkyl, halo-(C₁-C₆)-alkyl, (C₂-C₆)-alkenyl, (C₂-C₆)-haloalkenyl, (C₂-C₆)-alkynyl, (C₂-C₆)-haloalkynyl, or NR′R″ forms a heterocyclic ring which may be saturated, unsaturated or aromatic and which preferably contains 4-6 ring atoms and one or more heteroatoms from the group consisting of N, O and S and which may be unsubstituted or substituted by one or more substituents, preferably from the group consisting of (C₁-C₃)-alkyl, (C₁-C₃)-alkoxy, halo-(C₁-C₃)-alkyl, halo-(C₁-C₃)-alkoxy and halogen.

Particularly preferred heteroarylsulfonylureas are, for example, nicosulfuron and its salts, such as the sodium salt, rimsulfuron and its salts, such as the sodium salt, thifensulfuron-methyl and its salts, such as the sodium salt, pyrazosulfuron-ethyl and its salts, such as the sodium salt, flupyrsulfuron-methyl and its salts, such as the sodium salt, sulfosulfuron and its salts, such as the sodium salt, trifloxysulfuron and its salts, such as the sodium salt, azimsulfuron and its salts, such as the sodium salt, flazasulfuron and its salts, such as the sodium salt, and flucetosulfuron (1-[3-[[[[(4,6-dimethoxy-2-pyrimidinyl)amino]carbonyl]amino]sulfonyl]-2-pyrimidinyl]-2-fluoropropyl methoxyacetate) and its salts, such as the sodium salt.

The active compounds listed above are known, for example, from “The Pesticide Manual”, 12th edition, The British Crop Protection Council (2000), or the literature references given after the individual active compounds.

For the purpose of the present invention, the sulfonamides of the formula (I) (component a) contained in the solid, water-dispersible formulations according to the invention are in each case to be understood as meaning all use forms, such as acids, esters, salts and isomers, such as stereoisomers and optical isomers. Thus, in addition to neutral compounds, their salts with inorganic and/or organic counterions are in each case meant to be included. Thus, sulfonamides are capable of forming salts, for example, in which the hydrogen of the —SO₂—NH group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in the abovementioned description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids.

An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{z} is aminocarbonyl or aminosulfonyl, where the two last-mentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkylcarbonyl, phenylcarbonyl, where the phenyl ring may be substituted, or alkyloxycarbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Unsubstituted or substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl. Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methyl-prop-2-en-1-yl, but-2-en-1-yl, but-3-en-1-yl, 1-methyl-but-3-en-1-yl and 1-methyl-but-2-en-1-yl; alkynyl is, for example, propargyl, but-2-yn-1-yl, but-3-yn-1-yl, 1-methyl-but-3-yn-1-yl. Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

From among the active compounds from the group of the sulfonamides of the formula (I) and their salts (component a) very particular preference is given to azimsulfuron and its salts, such as the sodium salt, bensulfuron-methyl, chlorimuronethyl, chlorsulfuron, ethametsulfuron-methyl, flupyrsulfuron-methyl and its salts, such as the sodium salt, metsulfuron-methyl, nicosulfuron and its salts, such as the sodium salt, rimsulfuron and its salts, such as the sodium salt, sulfometuron-methyl, thifensulfuron-methyl and its salts, such as the sodium salt, tribenuron-methyl, triflusulfuron-methyl, methyl 4-[(4,5-dihydro-3-methoxy-4-methyl-5-oxo-1H-1,2,4-triazol-1-yl)carboxamidosulfonyl]-5-methylthiophene-3-carboxylate and its sodium salt, and also foramsulfuron and its sodium salt.

The formulations according to the invention comprise the active compounds from the group of the sulfonamides of the formula (I) and their salts (component a) in general in amounts of from 0.1 to 80% by weight, preferably from 1 to 75% by weight, particularly preferably from 3 to 50% by weight, very particularly preferably from 5 to 25% by weight; here and in the entire description, the term “% by weight” (percent by weight) refers to the relative weight of the component in question based on the total weight of the formulation, unless defined otherwise.

The active compounds referred to by the term “safeners”, which may optionally be present as component (b) are to be understood as meaning compounds which are suitable for reducing phytotoxic actions of active crop protection agents, such as herbicides, on crop plants.

The safeners (component b) are preferably selected from the group consisting of:
a) Compounds of the formulae (S-II) to (S-IV), 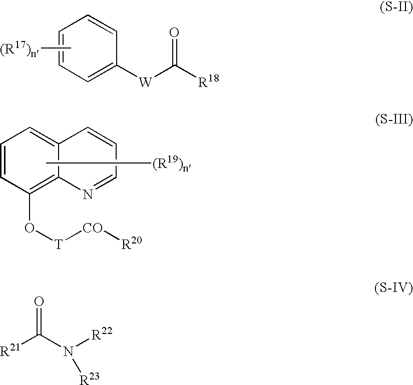
where the symbols and indices are as defined below:
n′ is a natural number from 0 to 5, preferably from 0 to 3;
T is a (C₁ or C₂)-alkanediyl chain which is unsubstituted or substituted by one or two (C₁-C₄)-alkyl radicals or by [(C₁-C₃)-alkoxy]carbonyl;
W is an unsubstituted or substituted divalent heterocyclic radical from the group of the partially unsaturated or aromatic five-membered heterocycles having 1 to 3 heteroring atoms of the type N or O, where the ring comprises at least one N-atom and at most one O-atom, preferably a radical from the group consisting of (W1) to (W4), 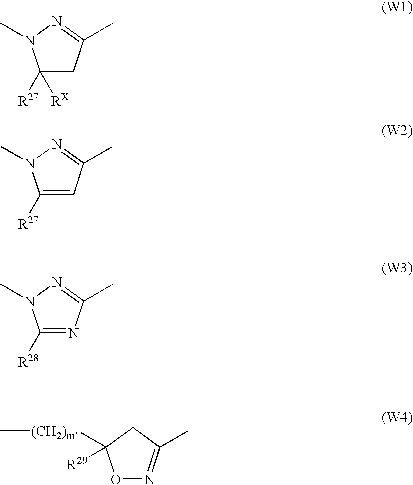
m′ is 0 or 1;
R¹⁷, R¹⁹ are identical or different halogen, (C₁-C₄)-alkyl, (C₁-C₄)-alkoxy, nitro or (C₁-C₄)-haloalkyl radicals;
R¹⁸, R²⁰ are identical or different OR²⁴, SR²⁴ or NR²⁴R²⁵ radicals or a saturated or unsaturated 3- to 7-membered heterocycle having at least one N-atom and up to 3 heteroatoms, preferably from the group consisting of O and S, which is attached via the N-atom to the carbonyl group in (S-II) or (S-III) and which is unsubstituted or substituted by radicals from the group consisting of (C₁-C₄)-alkyl, (C₁-C₄)-alkoxy and optionally substituted phenyl, preferably a radical of the formula OR²⁴, NHR²⁵ or N(CH₃)₂, in particular of the formula OR²⁴;
R²⁴ is hydrogen or an unsubstituted or substituted aliphatic hydrocarbon radical, preferably having a total of 1 to 18 carbon atoms;
R²⁵ is hydrogen, (C₁-C₆)-alkyl, (C₁-C₆)-alkoxy or substituted or unsubstituted phenyl;
R^{X} is H, (C₁-C₈)-alkyl, (C₁-C₈)-haloalkyl, (C₁-C₄)-alkoxy-(C₁-C₈)-alkyl, cyano or COOR²⁶, where R²⁶ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R²⁷, R²⁸, R²⁹ are identical or different and are hydrogen, (C₁-C₈)-alkyl, (C₁-C₈)-haloalkyl, (C₃-C₁₂)-cycloalkyl or substituted or unsubstituted phenyl;
R²¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R²², R²³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R²² and R²³ together form a substituted or unsubstituted heterocyclic ring,
   preferably an oxazolidine, thiazolidine, piperidine, morpholine,
   hexahydropyrimidine or benzoxazine ring;
      preferably safeners from the following subgroups of compounds of the formulae (S-II) to (S-IV):
   compounds of the type of the dichlorophenylpyrazoline-3-carboxylic acid (i.e. of the formula (S-II) in which W=(W1) and (R¹⁷)_{n′}=2,4-Cl₂), preferably compounds such as ethyl 1-(2,4-dichlorophenyl)-5-(ethoxycarbonyl)-5-methyl-2-pyrazoline-3-carboxylate (II-1, mefenpyr-diethyl), mefenpyr-dimethyl and mefenpyr (II-0), and related compounds, as described in WO-A-91/07874;
   derivatives of dichlorophenylpyrazolecarboxylic acid (i.e. of the formula (S-II) in which W=(W2) and (R¹⁷))_{n′}=2,4-Cl₂), preferably compounds such as ethyl 1-(2,4-dichlorophenyl)-5-methylpyrazole-3-carboxylate (II-2), ethyl 1-(2,4-dichlorophenyl)-5-isopropylpyrazole-3-carboxylate (II-3), ethyl 1-(2,4-dichlorophenyl)-5-(1,1-dimethylethyl)pyrazole-3-carboxylate (II-4), ethyl 1-(2,4-dichlorophenyl)-5-phenylpyrazole-3-carboxylate (II-5) and related compounds, as described in EP-A-0333131 and EP-A-0269806;
   compounds of the type of the triazolecarboxylic acids (i.e. of the formula (S-II) in which W=(W3) and (R¹⁷)_{n′}=2,4-C₁₂), preferably compounds such as fenchlorazole-ethyl, i.e. ethyl 1-(2,4-dichlorophenyl)-5-trichloromethyl-(1H)-1,2,4-triazole-3-carboxylate (II-6), and related compounds (see EP-A-0174562 and EP-A-0346620);
   compounds of the type of the 5-benzyl- or 5-phenyl-2-isoxazoline-3-carboxylic acid or the 5,5-diphenyl-2-isoxazoline-3-carboxylic acid, such as isoxadifen (II-12), (in which W=(W4)), preferably compounds such as ethyl 5-(2,4-dichlorobenzyl)-2-isoxazoline-3-carboxylate (II-7) or ethyl 5-phenyl-2-isoxazoline-3-carboxylate (II-8) and related compounds, as described in WO-A-91/08202, or ethyl 5,5-diphenyl-2-isoxazoline carboxylate (II-9, isoxadifen-ethyl) or n-propyl 5,5-diphenyl-2-isoxazoline carboxylate (II-10) or ethyl 5-(4-fluorophenyl)-5-phenyl-2-isoxazoline-3-carboxylate (II-11), as described in WO-A-95/07897.
   Compounds of the type of the 8-quinolineoxyacetic acid, for example those of the formula (S-III) in which (R¹⁹)_{n′}=5-Cl, R²⁰=OR²⁴ and T=CH₂, preferably the compounds 1-methylhexyl (5-chloro-8-quinolineoxy)acetate (III-1, cloquintocetmexyl), 1,3-dimethylbut-1-yl (5-chloro-8-quinolineoxy)acetate (III-2), 4-allyloxybutyl (5-chloro-8-quinolineoxy)acetate (III-3), 1-allyloxyprop-2-yl (5-chloro-8-quinolineoxy)acetate (III-4), ethyl (5-chloro-8-quinolineoxy)acetate (III-5), methyl (5-chloro-8-quinolineoxy)acetate (III-6), allyl (5-chloro-8-quinolineoxy)acetate (III-7), 2-(2-propylideneiminoxy)-1-ethyl (5-chloro-8-quinolineoxy)acetate (III-8), 2-oxoprop-1-yl (5-chloro-8-quinolineoxy)acetate (III-9), (5-chloro-8-quinolineoxy)acetic acid (III-10) and its salts, as described, for example in WO-A-02/34048, and related compounds, as described in EP-A-0860750, EP-A-0094349 and EP-A-0191736 or EP-A-0492366.
   Compounds of the type of the (5-chloro-8-quinolineoxy)malonic acid, i.e. of the formula (S-III) in which (R¹⁹)_{n′}=5-Cl, R²⁰=OR²⁴, T=—CH(COO-alkyl)-, preferably the compounds diethyl (5-chloro-8-quinolineoxy)malonate (III-11), diallyl (5-chloro-8-quinolineoxy)malonate, methyl ethyl (5-chloro-8-quinolineoxy)malonate and related compounds, as described in EP-A-0582198.
   Compounds of the type of the dichloroacetamides, i.e. of the formula (S-IV), preferably: N,N-diallyl-2,2-dichloroacetamide (dichlormid (IV-1), from U.S. Pat. No. 4,137,070), 4-dichloroacetyl-3,4-dihydro-3-methyl-2H-1,4-benzoxazine (IV-2, benoxacor, from EP 0149974), N1,N2-diallyl-N-2-dichloroacetylglycinamide (DKA-24 (IV-3), from HU 2143821), 4-dichloroacetyl-1-oxa-4-azaspiro[4,5]decane (AD-67), 2,2-dichloro-N-(1,3-dioxolan-2-ylmethyl)-N-(2-propenyl)acetamide (PPG-1292), 3-dichloroacetyl-2,2,5-trimethyloxazolidine (R-29148, IV-4), 3-dichloroacetyl-2,2-dimethyl-5-phenyloxazolidine, 3-dichloroacetyl-2,2-dimethyl-5-(2-thienyl)oxazolidine, 3-dichloroacetyl-5-(2-furanyl)-2,2-dimethyloxazolidine (furilazole (IV-5), MON 13900), 1-dichloroacetylhexahydro-3,3,8a-trimethylpyrrolo[1,2-a]pyrimidine-6(2H)-one (dicyclonon, BAS 145138),
      b) one or more compounds from the group consisting of: 1,8-naphthalic anhydride, methyl diphenylmethoxyacetate, 1-(2-chlorobenzyl)-3-(1-methyl-1-phenylethyl)urea (cumyluron), O,O-diethyl S-2-ethylthioethyl phosphorodithioate (disulfoton), 4-chlorophenyl methylcarbamate (mephenate), O,O-diethyl O-phenyl phosphorothioate (dietholate), 4-carboxy-3,4-dihydro-2H-1-benzopyran-4-acetic acid (CL-304415, CAS-Regno: 31541-57-8), cyanomethoxyimino(phenyl)acetonitrile (cyometrinil), 1,3-dioxolan-2-ylmethoxyimino(phenyl)acetonitrile (oxabetrinil), 4′-chloro-2,2,2-trifluoroacetophenone O-1,3-dioxolan-2-ylmethyloxime (fluxofenim), 4,6-dichloro-2-phenylpyrimidine (fenclorim), benzyl 2-chloro-4-trifluoromethyl-1,3-thiazole-5-carboxylate (flurazole), 2-dichloromethyl-2-methyl-1,3-dioxolane (MG-191), N-(4-methylphenyl)-N′-(1-methyl-1-phenylethyl)urea (dymron), (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor) and their salts and esters, preferably (C₁-C₈);
      c) N-acylsulfonamides of the formula (S-V) and their salts, 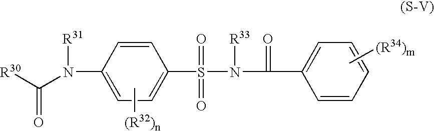
      in which
R³⁰ is hydrogen, a hydrocarbon radical, a hydrocarbonoxy radical, a hydrocarbonthio radical or a heterocyclyl radical which is preferably attached via a C atom, where each of the 4 last-mentioned radicals is unsubstituted or substituted by one or more identical or different radicals from the group consisting of halogen, cyano, nitro, amino, hydroxyl, carboxyl, formyl, carbonamide, sulfonamide and radicals of the formula -Z^{a}-R^{a}, where each hydrocarbon moiety has preferably 1 to 20 C-atoms and a C-containing radical R³⁰ including substituents has preferably 1 to 30 C-atoms;
R³¹ is hydrogen or (C₁-C₄)-alkyl, preferably hydrogen, or
R³⁰ and R³¹ together with the group of the formula —CO—N— are the radicals of a 3- to 8-membered saturated or unsaturated ring;
R³² are identical or different radicals from the group consisting of halogen, cyano, nitro, amino, hydroxyl, carboxyl, formyl, CONH₂, SO₂NH₂ or a radical of the formula -Z^{b}-R^{b};
R³³ is hydrogen or (C₁-C₄)-alkyl, preferably H;
R³⁴ are identical or different radicals from the group consisting of halogen, cyano, nitro, amino, hydroxyl, carboxyl, CHO, CONH₂, SO₂NH₂ and a radical of the formula -Z^{c}R^{c};
R^{a} is a hydrocarbon radical or a heterocyclyl radical, where each of the two last-mentioned radicals is unsubstituted or substituted by one or more identical or different radicals from the group consisting of halogen, cyano, nitro, amino, hydroxyl, mono- and di-[(C₁-C₄)-alkyl]amino, or an alkyl radical in which a plurality, preferably 2 or 3, non-adjacent CH₂ groups are in each case replaced by an oxygen atom;
R^{b},R^{c} are identical or different and are a hydrocarbon radical or a heterocyclyl radical, where each of the two last-mentioned radicals is unsubstituted or substituted by one or more identical or different radicals from the group consisting of halogen, cyano, nitro, amino, hydroxyl, phosphoryl, halo-(C₁-C₄)-alkoxy, mono- and di-[(C₁-C₄)-alkyl]amino, or an alkyl radical in which a plurality, preferably 2 or 3, non-adjacent CH₂ groups are in each case replaced by an oxygen atom;
Z^{a} is a divalent group of the formula —O—, —S—, —CO—, —CS—, —CO—O—, —CO—S—, —O—CO—, —S—CO—, —SO—, —SO₂—, —NR*—, —CO—NR*—, —NR*—CO—, —SO₂—NR*— or —NR*—SO₂—, where the bond indicated on the right-hand side of the divalent group in question is the bond to the radical R^{a} and where the R* in the 5 last-mentioned radicals independently of one another are each H, (C₁-C₄)-alkyl or halo-(C₁-C₄)-alkyl;
Z^{b}, Z^{c} independently of one another are a direct bond or a divalent group of the formula —O—, —S—, —CO—, —CS—, —CO—O—, —CO—S—, —O—CO—, —S—CO—, —SO—, —SO₂—, —NR*—, —SO₂—NR*—, —NR*—SO₂—, —CO—NR*— or —NR*—CO—, where the bond indicated on the right-hand side of the divalent group in question is the bond to the radical R^{b} or R^{c} and where R* in the 5 last-mentioned radicals independently of one another are each H, (C₁-C₄)-alkyl or halo-(C₁-C₄)-alkyl;
n is an integer from 0 to 4, preferably 0, 1 or 2, particularly preferably 0 or 1, and
m is an integer from 0 to 5, preferably 0, 1, 2 or 3, in particular 0, 1 or 2;
   preferably safeners of compounds of the formula (S-V), in which
   R³⁰=H₃C—O—CH₂—, R³¹=R³³=H, R³⁴=2-OMe (V-1),
   R³⁰=H₃C—O—CH₂—, R³¹=R³³=H, R³⁴=2-OMe-5-Cl (V-2),
   R³⁰=cyclopropyl, R³¹=R³³=H, R³⁴=2-OMe (V-3),
   R³⁰=cyclopropyl, R³¹=R³³=H, R³⁴=2-OMe-5-Cl (V-4),
   R³⁰=cyclopropyl, R³¹=R³³=H, R³⁴=2-Me (V-5),
   R³⁰=tert-butyl, R³¹=R³³=H, R³⁴=2-OMe (V-6).
      d) Acylsulfamoylbenzamides of the general formula (S-VI), if appropriate also in salt form, 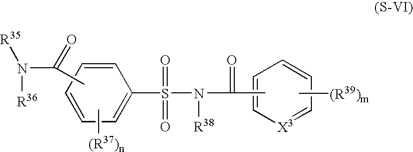
      in which
X³ is CH or N;
R³⁵ is hydrogen, heterocyclyl or a hydrocarbon radical where the two last-mentioned radicals are optionally substituted by one or more identical or different radicals from the group consisting of halogen, cyano, nitro, amino, hydroxyl, carboxyl, CHO, CONH₂, SO₂NH₂ and Z^{a}-R^{a};
R³⁶ is hydrogen, hydroxyl, (C₁-C₆)-alkyl, (C₂-C₆)-alkenyl, (C₂-C₆)-alkynyl, (C₁-C₆)-alkoxy, (C₂-C₆)-alkenyloxy, where the five last-mentioned radicals are optionally substituted by one or more identical or different radicals from the group consisting of halogen, hydroxyl, (C₁-C₄)-alkyl, (C₁-C₄)-alkoxy and (C₁-C₄)-alkylthio, or
R³⁵ and R³⁶ together with the nitrogen atom that carries them are a 3- to 8-membered saturated or unsaturated ring;
R³⁷ is halogen, cyano, nitro, amino, hydroxyl, carboxyl, CHO, CONH₂, SO₂NH₂ or Z^{b}-R^{b};
R³⁸ is hydrogen, (C₁-C₄)-alkyl, (C₂-C₄)-alkenyl or (C₂-C₄)-alkynyl;
R³⁹ is halogen, cyano, nitro, amino, hydroxyl, carboxyl, phosphoryl, CHO, CONH₂, SO₂NH₂ or Z^{c}-R^{c};
R^{a} is a (C₂-C₂₀)-alkyl radical whose carbon chain is interrupted once or more than once by oxygen atoms, is heterocyclyl or a hydrocarbon radical, where the two last-mentioned radicals are optionally substituted by one or more identical or different radicals from the group consisting of halogen, cyano, nitro, amino, hydroxyl, mono- and di-[(C₁-C₄)-alkyl]amino;
R^{b}, R^{c} are identical or different and are a (C₂-C₂₀)alkyl radical whose carbon chain is interrupted once or more than once by oxygen atoms, are heterocyclyl or a hydrocarbon radical, where the two last-mentioned radicals are optionally substituted by one or more identical or different radicals from the group consisting of halogen, cyano, nitro, amino, hydroxyl, phosphoryl, (C₁-C₄)-haloalkoxy, mono- and di-[(C₁-C₄)-alkyl]amino
Z^{a} is a divalent unit from the group consisting of O, S, CO, CS, C(O)O, C(O)S, SO, SO₂, NR^{d}, C(O)NR^{d} and SO₂NR^{d};
Z^{b}, Z^{c} are identical or different and are a direct bond or divalent unit from the group consisting of O, S, CO, CS, C(O)O, C(O)S, SO, SO₂, NR^{d}, SO₂NR^{d} and C(O)NR^{d};
R^{d} is hydrogen, (C₁-C₄)-alkyl or (C₁-C₄)-haloalkyl;
n is an integer from 0 to 4, and
m, if X is CH is an integer from 0 to 5, and if X is N, is an integer from 0 to 4;
   preferably safeners of compounds of the formula (S-VI) in which
X³ is CH;
R³⁵ is hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to three heteroatoms from the group consisting of nitrogen, oxygen and sulfur, where the six last-mentioned radicals are optionally substituted by one or more identical or different substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R³⁶ is hydrogen, (C₁-C₆)-alkyl, (C₂-C₆)-alkenyl, (C₂-C₆)-alkynyl, where the three last-mentioned radicals are optionally substituted by one or more identical or different substituents from the group consisting of halogen, hydroxyl, (C₁-C₄)-alkyl, (C₁-C₄)-alkoxy and (C₁-C₄)-alkylthio;
R³⁷ is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R³⁸ is hydrogen;
R³⁹ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n is 0, 1 or 2 and
m is 1 or 2.

In particular compounds of the type of the acylsulfamoylbenzamides of the formula (S-VII) below, which are known, for example from WO-A-99/16744, 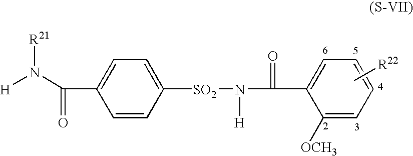
in which
R²¹=cyclopropyl and R²²=H(S3-1=4-cyclopropylaminocarbonyl-N-(2-methoxybenzoyl)benzenesulfonamide, cyprosulfamide),
R²¹=cyclopropyl and R²²=5-Cl (S3-2),
R²¹=ethyl and R²²=H(S3-3),
R²¹=isopropyl and R²²=5-Cl (S3-4) and
R²¹=isopropyl and R²²=H(S3-5=4-isopropylaminocarbonyl-N-(2-methoxybenzoyl)benzenesulfonamide);
   e) compounds of the type of the N-acylsulfamoylphenylureas of the formula (S-VIII), which are known, for example, from EP-A-365484, 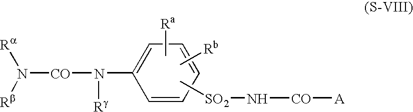
   in which
A is a radical from the group consisting of 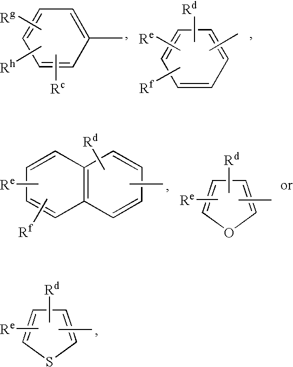
R^{α} and R^{β} independently of one another are hydrogen, C₁-C₈-alkyl, C₃-C₈-cycloalkyl, C₃-C₆-alkenyl, C₃-C₆-alkynyl, 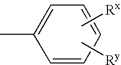
or C₁-C₄-alkoxy which is substituted by 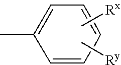
or C₁-C₄-alkoxy, or
R^{α} and R^{β} together are a C₄-C₆-alkylene bridge or a C₄-C₆-alkylene bridge which is interrupted by oxygen, sulfur, SO, SO₂, NH or —N(C₁-C₄-alkyl)-,
R^{γ} is hydrogen or C₁-C₄-alkyl,
R^{a} and R^{b} independently of one another are hydrogen, halogen, cyano, nitro, trifluoromethyl, C₁-C₄-alkyl, C₁-C₄-alkoxy, C₁-C₄-alkylthio, C₁-C₄-alkylsulfinyl, C₁-C₄-alkylsulfonyl, —COOR^{j} is, —CONR^{k}R^{m}, —CORⁿ, SO₂NR^{k}R^{m} or —OSO₂—C₁-C₄-alkyl, or R^{a} and R^{b} together are a C₃-C₄-alkylene bridge which may be substituted by halogen or C₁-C₄-alkyl, or a C₃-C₄-alkenylene bridge which may be substituted by halogen or C₁-C₄-alkyl, or a C₄-alkadienylene bridge which may be substituted by halogen or C₁-C₄-alkyl, and
R^{g} and R^{h} independently of one another are hydrogen, halogen, C₁-C₄-alkyl, trifluoromethyl, methoxy, methylthio or —COOR^{j}, where
R^{c} is hydrogen, halogen, C₁-C₄-alkyl or methoxy,
R^{d} is hydrogen, halogen, nitro, C₁-C₄-alkyl, C₁-C₄-alkoxy, C₁-C₄-alkylthio, C₁-C₄-alkylsulfinyl, C₁-C₄-alkylsulfonyl, —COOR^{j} or —CONR^{k}R^{m},
R^{e} is hydrogen, halogen, C₁-C₄-alkyl, —COOR^{j}, trifluoromethyl or methoxy, or R^{d} and R^{e} together are a C₃-C₄-alkylene bridge,
R^{f} is hydrogen, halogen or C₁-C₄-alkyl,
R^{X} and R^{Y} independently of one another are hydrogen, halogen, C₁-C₄-alkyl, C₁-C₄-alkoxy, C₁-C₄-alkylthio, —COOR⁴, trifluoromethyl, nitro or cyano,
R^{j}, R^{k} and R^{m} independently of one another are hydrogen or C₁-C₄-alkyl,
R^{k} and R^{m} together are a C₄-C₆-alkylene bridge or a C₄-C₆-alkylene bridge which is interrupted by oxygen, NH or —N(C₁-C₄-alkyl)-, and
Rⁿ is C₁-C₄-alkyl, phenyl or phenyl which is substituted by halogen, C₁-C₄-alkyl, methoxy, nitro or trifluoromethyl;
   preferred safeners of the formula (S-VIII) are
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea,
   including the stereoisomers and the agriculturally customary salts.

Unless specifically defined otherwise, the following definitions generally apply to the radicals in the formulae (S-I) to (S-VIII).

In the carbon skeleton, the radicals alkyl, alkoxy, haloalkyl, haloalkoxy, alkylamino and alkylthio and the corresponding unsaturated and/or substituted radicals may in each case be straight-chain or branched.

Alkyl radicals, including in the composite meanings, such as alkoxy, haloalkyl, etc., preferably have 1 to 4 C-atoms and are, for example, methyl, ethyl, n- or isopropyl, n-, iso-, tert- or 2-butyl. Alkenyl and alkynyl radicals have the meaning of the unsaturated radicals which are possible and correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl. Alkynyl is, for example, propargyl, but-2-yn-1-yl, but-3-yn-1-yl, 1-methylbut-3-yn-1-yl. “(C₁-C₄)-alkyl” is the short notation of alkyl having 1 to 4 C-atoms; this applies correspondingly to other general radical definitions where the ranges of the possible number of C-atoms are indicated in brackets.

Cycloalkyl is preferably a cyclic alkyl radical having 3 to 8, preferably 3 to 7, particularly preferably 3 to 6, C-atoms, for example cyclopropyl, cyclobutyl, cyclopentyl and cyclohexyl. Cycloalkenyl and cycloalkynyl refer to the corresponding unsaturated compounds.

Halogen is fluorine, chlorine, bromine or iodine. Haloalkyl, haloalkenyl and haloalkynyl are alkyl, alkenyl and alkynyl, respectively, which are partially or fully substituted by halogen, preferably by fluorine, chlorine and/or bromine, in particular by fluorine or chlorine, for example CF₃, CHF₂, CH₂F, CF₂CF₃, CH₂CHFCl, CCl₃, CHCl₂, CH₂CH₂Cl. Haloalkoxy is, for example, OCF₃, OCHF₂, OCH₂F, OCF₂CF₃, OCH₂CF₃ and OCH₂CH₂Cl. This applies correspondingly to other halogen-substituted radicals.

A hydrocarbon radical may be an aromatic or an aliphatic hydrocarbon radical, where an aliphatic hydrocarbon radical is generally a straight-chain or branched saturated or unsaturated hydrocarbon radical having preferably 1 to 18, particularly preferably 1 to 12, C-atoms, for example alkyl, alkenyl or alkynyl.

An aliphatic hydrocarbon radical is preferably alkyl, alkenyl or alkynyl having up to 12 C-atoms; this applies correspondingly to an aliphatic hydrocarbon radical in a hydrocarbonoxy radical.

Aryl is generally a mono-, bi- or polycyclic aromatic system having preferably 6-20 C-atoms, with preference 6 to 14 C-atoms, particularly preferably 6 to 10 C-atoms, for example phenyl, naphthyl, tetrahydronaphthyl, indenyl, indanyl, pentalenyl and fluorenyl, particularly preferably phenyl.

A heterocyclic ring, heterocyclic radical or heterocyclyl is a mono-, bi- or polycyclic ring system which is saturated, unsaturated and/or aromatic and contains one or more, preferably 1 to 4, heteroatoms, preferably from the group consisting of N, S and O.

Preference is given to saturated heterocycles having 3 to 7 ring atoms and one or two heteroatoms from the group consisting of N, O and S, where the chalcogenes are not adjacent. Particular preference is given to monocyclic rings having 3 to 7 ring atoms and one heteroatom from the group consisting of N, O and S, and also to morpholine, dioxolane, piperazine, imidazoline and oxazolidine. Very particularly preferred saturated heterocycles are oxirane, pyrrolidone, morpholine and tetrahydrofuran. Preference is also given to partially unsaturated heterocycles having 5 to 7 ring atoms and one or two heteroatoms from the group consisting of N, O and S. Particular preference is given to partially unsaturated heterocycles having 5 or 6 ring atoms and one heteroatom from the group consisting of N, O and S. Very particularly preferred partially unsaturated heterocycles are pyrazoline, imidazoline and isoxazoline.

Preference is also given to heteroaryl, for example mono- or bicyclic aromatic heterocycles having 5 to 6 ring atoms which contain one to four heteroatoms from the group consisting of N, O, S, where the chalcogenes are not adjacent. Particular preference is given to monocyclic aromatic heterocycles having 5 or 6 ring atoms which contain a heteroatom from the group consisting of N, O and S, and also pyrimidine, pyrazine, pyridazine, oxazole, thiazole, thiadiazole, oxadiazole, pyrazole, triazole and isoxazole. Very particular preference is given to pyrazole, thiazole, triazole and furan.

Substituted radicals, such as substituted hydrocarbon radicals, for example substituted alkyl, alkenyl, alkynyl, aryl, such as phenyl, and arylalkyl, such as benzyl, or substituted heterocyclyl are a substituted radical derived from the unsubstituted skeleton, where the substituents are preferably one or more, preferably 1, 2 or 3, in the case of Cl and F also up to the maximum possible number, of substituents from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino and alkylsulfinyl, haloalkylsulfinyl, alkylsulfonyl, haloalkylsulfonyl and, in the case of cyclic radicals, also alkyl and haloalkyl, and also unsaturated aliphatic substituents corresponding to the saturated hydrocarbon-containing substituents mentioned, preferably alkenyl, alkynyl, alkenyloxy, alkynyloxy. In the case of radicals having C-atoms, preference is given to those having 1 to 4 C-atoms, in particular 1 or 2 C-atoms. In general, preference is given to substituents from the group consisting of halogens, for example, fluorine or chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Mono- or disubstituted amino is a chemically stable radical from the group of the substituted amino radicals which are N-substituted, for example, by one or two identical or different radicals from the group consisting of alkyl, alkoxy, acyl and aryl; preferably monoalkylamino, dialkylamino, acylamino, arylamino, N-alkyl-N-arylamino and also N-heterocycles. Preference is given here to alkyl radicals having 1 to 4 C-atoms. Here, aryl is preferably phenyl. Here, substituted aryl is preferably substituted phenyl. For acyl, the definition given further below applies, preferably (C₁-C₄)-alkanoyl. This applies correspondingly to substituted hydroxylamino or hydrazino.

Optionally substituted phenyl is preferably phenyl which is unsubstituted or mono- or polysubstituted, preferably up to trisubstituted, in the case of halogens such as Cl and F also up to pentasubstituted, by identical or different radicals from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyls, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

An acyl radical is a radical of an organic acid having preferably up to 6 C-atoms, for example the radical of a carboxylic acid and radicals of acids derived thereform, such as thiocarboxylic acid, optionally N-substituted iminocarboxylic acids, or the radical of carbonic monoesters, optionally N-substituted carbaminic acids, sulfonic acids, sulfinic acids, phosphonic acids, phosphinic acids. Acyl is, for example, formyl, alkylcarbonyl, such as (C₁-C₄-alkyl)carbonyl, phenylcarbonyl, where the phenyl ring may be substituted, for example as indicated above for phenyl, or alkyloxycarbonyl, phenyloxycarbonyl, benzyloxycarbonyl, alkylsulfonyl, alkylsulfinyl or N-alkyl-1-iminoalkyl.

The formulae (S-II) to (S-VIII) also embrace all stereoisomers in which the atoms are linked in the same topological manner, and mixtures thereof. Such compounds contain one or more asymmetric C-atoms or else double bonds, which are not specifically indicated in the general formulae. The possible stereoisomers, defined by their specific spatial form, such as enantiomers, diastereoisomers, Z and E isomers, can be obtained by customary methods from mixtures of the stereoisomers or else be prepared by stereoselective reactions in combination with the use of stereochemically pure starting materials.

The compounds of the formula (S-II) are known, for example, from EP-A-0333131 (ZA-89/1960), EP-A-0269806 (U.S. Pat. No. 4,891,057), EP-A-0346620 (AU-A-89/34951), EP-A-0174562, EP-A-0346620 (WO-A-91/08202), WO-A-91/07874 or WO-A-95/07897 (ZA 94/7120) and the literature cited therein or can be prepared by or analogously to the processes described therein. The compounds of the formula (S-III) are known from EP-A-0086750, EP-A-094349 (U.S. Pat. No. 4,902,340), EP-A-0191736 (U.S. Pat. No. 4,881,966) and EP-A-0492366 and the literature cited therein and can be prepared by or analogously to the processes described therein. Some compounds are furthermore described in EP-A-0582198 and WO-A-02/34048. The compounds of the formula (S-IV) are known from numerous patent applications, for example U.S. Pat. No. 4,021,224 and U.S. Pat. No. 4,021,229. Compounds of the subgroup b) are furthermore known from CN-A-87/102789, EP-A-365484 and also from “The Pesticide Manual”, 11th to 13th edition, British Crop Protection Council and the Royal Society of Chemistry (1997). The compounds of the subgroup c) are described in WO-A-97/45016, those of subgroup d) in WO-A-99/16744, (in particular in EP-A-365484). The publications cited contain details of preparation processes and starting materials and mention preferred compounds. These publications are expressly incorporated into the present description by way of reference.

Preference is given to safeners (component b) having melting points≦(smaller than or equal to) 150° C., particularly preferably≦100° C., very particularly preferably≦75° C. In addition, preference is given to safeners (component b) suitable for use in cereals, such as, for example, wheat, barley, rye, oats, millet, rice, corn.

Particularly preferred safeners (component b) which may optionally be present in the formulations according to the invention are, inter alia: 4-dichloroacetyl-1-oxa-4-azaspiro[4.5]decane (AD-67), 1-dichloroacetylhexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinoline-8-oxyacetic acid (cloquintocet-mexyl), α-(cyanomethoxyimino)phenylacetonitrile (cyometrinil), 2,2-dichloro-N-(2-oxo-2-(2-propenylamino)ethyl)-N-(2-propenyl)-acetamide (DKA-24), 2,2-dichloro-N,N-di-2-propenylacetamide (dichlormid), N-(4-methylphenyl)-N′-(1-methyl-1-phenylethyl)urea (dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl), phenylmethyl 2-chloro-4-trifluoromethylthiazole-5-carboxylate (flurazole), 4-chloro-N-(1,3-dioxolan-2-ylmethoxy)-α-trifluoroacetophenonoxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolcarboxylate (isoxadifen-ethyl), diethyl-1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoximino)-phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), methyl 1-(2-chlorophenyl)-5-phenyl-1H-pyrazole-3-carboxylate, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide and N-(2-methoxybenzoyl)-4-[(methylaminocarbonyl)amino]benzenesulfonamide.

Very particular preference is given to mefenpyr-diethyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide, and mefenpyr-diethyl is especially preferred.

The proportion of the safeners (component b) which are present in the formulations according to the invention may be 0.01-50% by weight, preferably 0.5-25% by weight, particularly preferably 2-20% by weight, very particularly preferably 5-17% by weight.

Solvents suitable for the formulations according to the invention (component c) are chosen from the group of the aromatic and aliphatic hydrocarbons, esters and amides of organic and inorganic acids, aromatic, aliphatic and cycloaliphatic ketones and alcohols.

Typical representatives of suitable solvents are, inter alia, ®Solvesso types (aromatic hydrocarbon), ®Essobayol (aliphatic hydrocarbon), ®Exxate (esters of organic acids), ®Hallcomide (amides of organic acids), acetophenone (aromatic ketone), methyl isobutyl ketone (aliphatic ketone), ®Anon (cyclohexanone: cycloaliphatic ketone).

Preference is given to solvents from the group of the aromatic and aliphatic hydrocarbons, such as, for example, ®Solvesso types (aromatic hydrocarbons), and aromatic hydrocarbons, such as ®Solvesso 200 ND (alkylated naphthalene), are particularly preferred.

The proportion of solvents (component c) in the formulations according to the invention may be 0.01-50% by weight, preferably 0.5-25%, particularly preferably 2-20% by weight, very particularly preferably 5-17% by weight.

In the formulations according to the invention, one or more carrier materials (component d) are used, selected from one or more of the following groups: carriers with low absorbency (component d-1) and carriers with high absorbency (component d-2).

The proportion of carrier materials (component d) in the formulations according to the invention may be 0.1-90% by weight, preferably 10-80% by weight, particularly preferably 15-50% by weight, very particularly preferably 25-45% by weight.

The carriers with low absorbency (component d-1) in the formulations according to the invention may be taken from a group comprising minerals, carbonates, sulfates and phosphates of alkaline earth metals and earth metals, such as calcium carbonate, polymeric carbohydrates, tectosilicates (framework silicates), such as precipitated silicic acids with low absorbency, and natural tectosilicates, such as kaolin. In addition, they are characterized by an absorbency of less than 200 g of dibutyl phthalate per 100 g of carrier material.

Typical representatives of suitable carriers (component d-1) are, inter alia, ®Agsorb LVM-GA (attapulgite), ®Harborlite 300 (perlite), ®Collys HV (modified starch), ®Omya chalk (calcium carbonate), ®Extrusil (precipitated silicic acid), ®Kaolin Tec 1 (kaolin, aluminum hydrosilicate), ®Steamic OOS (talc, magnesium silicate). Preference is given here to natural tectosilicates and calcium carbonate types, such as ®Omya chalk (calcium carbonate), ®Kaolin Tec1 (kaolin) and ®Harborlite 300 (perlite), and particular preference is given to natural tectosilicates, such as ®Kaolin Tec 1 (kaolin, aluminum hydrosilicate) and ®Harborlite 300 (perlite).

The proportion of carriers having low absorbency (component d-1) in the formulations according to the invention can be 0.5-85% by weight, preferably 7-70% by weight, particularly preferably 15-35% by weight.

Suitable carriers having high absorbency (component d-2) in the formulations according to the invention are characterized by an absorbency of at least 200 g of dibutyl phthalate per 100 g of carrier material and may be chosen from this group.

Typical representatives of carriers suitable for this purpose (component d-2) are, inter alia, ®Calflo E (calcium silicate) and ®Sipernat types (synthetic precipitated silicic acid of high absorbency).

Preference is given to calcium silicate, such as ® Calflo E, and precipitated silicic acid, such as ®Sipemat 50S.

The proportion of carriers with high absorbency (component d-2) in the formulations according to the invention may be 0.1-90% by weight, preferably 0.3-20% by weight, particularly preferably 1-17% by weight, very particularly preferably 3-13% by weight.

In a particular embodiment of the invention, the carrier materials (component d) consists of a mixture of at least one carrier with low absorbency (component d-1) and at least one carrier with high absorbency (component d-2).

In the formulations according to the invention, one or more customary auxiliaries and additives (component e) are used which are selected from one or more of the following groups: emulsifiers (component e-1), antifoams (component e-2), wetting agents (component e-3) and dispersants (component e-4).

The classification of the component (e) into emulsifiers, wetting agents and dispersants does not limit the use, since it is known that, for example, dispersants may also have “wetting” properties and, for example, wetting agents may also act as a dispersant.

Suitable customary auxiliaries and additives (component e) may be selected from one or more of the groups of the ionic, neutral and/or zwitterionic surfactants, and also from the groups of the neutral to (weakly) alkaline surfactants (pH 6-14).

Suitable emulsifiers (component e-1) may be of anionic and/or nonionic nature and are selected from the group comprising: salts of alkylated aromatic sulfonic acids, optionally alkylated copolymers of alkylene oxides, such as ethylene oxide and propylene oxide (EO/PO), ethoxylated castor oil, fatty-acylated sorbitan ethoxylate, mono- and diglycerides of fatty acids and their salts, fatty acids and their salts, reaction products of optionally aliphatically or aromatically substituted phenols with alkylene oxides, and also, if appropriate, the partial esters of these surfactants with organic acids, such as acetic acid or citric acid, or inorganic acids, such as sulfuric acid or phosphoric acid.

Typical representatives of suitable emulsifiers are, inter alia, ®Phenylsulfonat CA (Ca dodecylbenzenesulfonate), ®Soprophor types (optionally esterified derivatives of tristyrylphenol ethoxylates), ®Emulsogen 3510 (alkylated EO/PO copolymer), ®Emulsogen EL 400 (ethoxylated castor oil), ®Tween types (fatty-acylated sorbitan ethoxylates), ®Calsogen AR 100 (Ca dodecylbenzenesulfonate).

Preference is given to combinations of salts of alkylated aromatic sulfonic acids, such as ®Phenylsulfonat Ca and/or ®Calsogen AR 100, with alkylated copolymers of ethylene oxide and propylene oxide, such as Emulsogen 3510.

Particular preference is given to combinations of salts of dodecylbenzenesulfonic acid, such as ®Calsogen AR 100 with alkylated copolymer of ethylene oxide and propylene oxide, such as ®Emulsogen 3510.

The proportion of emulsifiers (component e-1) in the formulations according to the invention may be 0.001-25% by weight, preferably 0.005-10% by weight, particularly preferably 0.05-6% by weight, very particularly preferably 0.5-3.5% by weight.

Suitable antifoams (component e-2) may be selected from the group consisting of the esters of phosphoric acid with lower alcohols, C₆-C₁₀ alcohols, silicone surfactants (suspoemulsions of hydrophobicized silicic acid particles in aqueous emulsion concentrates based on liquid silicone surfactants), such as polydimethylsiloxane, and their absorbates on solid carrier material.

Typical representatives of suitable antifoams are, inter alia, ®Rhodorsil 432 (silicone surfactant), butyl phosphate, isobutyl phosphate, n-octanol, ®Wacker ASP15 (polydimethylsiloxane, absorbed on a solid carrier), ® Antischaum-Mittel SE 2 (polydimethylsiloxane).

Preferred are suspoemulsions of hydrophobicized silicic acid particles in aqueous emulsion concentrates based on liquid silicone surfactants, such as ®Antischaum-Mittel SE (polydimethylsiloxane), and solid antifoams, such as ®Wacker ASP 15 (polydimethylsiloxane).

The proportion of antifoams (component e-2) in the formulations according to the invention may be 0.1-10% by weight, preferably 0.3-5% by weight, particularly preferably 0.5-3% by weight.

Suitable wetting agents (component e-3) may be solid surfactants, anionic and/or zwitterionic surfactants, sulfonates (sulfosuccinates), sulfates, phosphonates, phosphates and carboxylates, and also alkaline surfactants (for example ®Synperonic T types). They can be selected from the group of solid, i.e. at room temperature non-liquid, wetting agents having, for example, a wax-like, amorphous or crystalline consistency, preferably from the group of the reaction products of alkylene oxides with alkylenepolyamines, of the naphthalenesulfonic acids and the group of the sulfosuccinic acid derivatives, and also the salts of these groups which may firstly comprise mono- and diesters of sulfosuccinic acid and their salts (sulfosuccinates) and secondly alkylated naphthalenesulfonic acid and their salts.

Typical representatives of suitable wetting agents are, inter alia, ®Synperonic T types (block polymers of propylene oxide and ethylene oxide on ethylenediamine), ®Aerosol OTB (dioctylsulfosuccinate), ®Morwet EFW (alkylated naphthalenesulfonates), ®Nekal BX (alkylated naphthalenesulfonates), ®Galoryl MT 804 (alkylated naphthalenesulfonates).

Preference is given here to block polymers of propylene oxide and ethylene oxide on ethylenediamine ®Synperonic T 905), the salts of alkylated naphthalenesulfonic acids and the salts of dioctylsulfosuccinic acid, particularly preferably the sodium salts of alkylated naphthalenesulfonates, such as, for example, ®Morwet EFW, and the sodium salts of the dioctylsulfosuccinic acid, such as, for example, ®Aerosol OTB, and block polymers of propylene oxide and ethylene oxide on ethylenediamine, such as, for example, ®Synperonic T 905.

The proportion of wetting agent (component e-3) in the formulations according to the invention may be 0.1-50% by weight, preferably 0.25-30% by weight, particularly preferably 0.5-30% by weight.

Suitable dispersants (component e-4) can be selected from the group consisting of ethoxylated triarylphenols, their (if appropriate partial) esters with phosphoric acid, lignosulfonic acids, condensates of aromatic, optionally polycyclic sulfonic acids (naphthalenesulfonic acid) with formaldehyde, polymers of optionally alkylated acrylic acids (example alkaline dispersants), condensates of optionally polycyclic phenols with formaldehyde and Na sulfite, sulfonic acids of polycyclic aromatics, and the alkali metal, alkaline earth metal and ammonium salts of these compounds.

Typical representatives of suitable dispersants are, inter alia, ®Soprophor BSU (phosphated triarylphenol ethoxylate), ®Borresperse NA (lignosulfonate), ®Rapidaminreserve D (condensate of phenol with Na sulfite and formaldehyde), ®Galoryl DT brands (condensate of aromatic sulfonic acids with formaldehyde), ®Morwet D425 (condensate of naphthalenesulfonic acid and formaldehyde).

Preference is given to condensates of aromatic sulfonic acids with formaldehyde and salts thereof, particular preference is given to the sodium salts of naphthalenesulfonic acids with formaldehyde, such as ®Galoryl DT505 and ®Morwet D425 (both condensates of naphthalenesulfonic acid and formaldehyde).

The proportion of the dispersants (component e-4) may be 1-50% by weight, preferably 5-30% by weight, particularly preferably 10-20% by weight.

Suitable agrochemically active compounds (component f), which may be present or not, are, for example, agrochemically active compounds different from components (a) and (b), such as herbicides, fungicides, insecticides, plant growth regulators and the like.

Suitable active compounds different from components (a) and (b) are preferably herbicidally active compounds. Here, mention may be made of herbicides from the group of the carbamates, thiocarbamates, haloacetanilides, substituted phenoxy-, naphthoxy- and phenoxyphenoxycarboxylic acid derivatives and also heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic acid esters, cyclohexanedione derivatives, phosphorus-containing herbicides, for example of the glufosinate type or the glyphosate type, and also S-(N-aryl-N-alkyl-carbamoylmethyl)dithiophosphoric esters, especially, for example:

A) herbicides of the type of the phenoxyphenoxy- and heteroaryloxyphenoxycarboxylic acid derivatives, such as

A1) phenoxyphenoxy- and benzyloxyphenoxycarboxylic acid derivatives, for example methyl 2-(4-(2,4-dichlorophenoxy)phenoxy)propionate (diclofop-methyl),

methyl 2-(4-(4-bromo-2-chlorophenoxy)phenoxy)propionate (DE-A-2601548),

methyl 2-(4-(4-bromo-2-fluorophenoxy)phenoxy)propionate (U.S. Pat. No. 4,808,750),

methyl 2-(4-(2-chloro-4-trifluoromethylphenoxy)phenoxy)propionate (DE-A-2433067),

methyl 2-(4-(2-fluoro-4-trifluoromethylphenoxy)phenoxy)propionate (U.S. Pat. No. 4,808,750),

methyl 2-(4-(2,4-dichlorobenzyl)phenoxy)propionate (DE-A-2417487),

ethyl 4-(4-(4-trifluoromethylphenoxy)phenoxy)pent-2-enoate,

methyl 2-(4-(4-trifluoromethylphenoxy)phenoxy)propionate (DE-A-2433067);

A2) “monocyclic” heteroaryloxyphenoxyalkanecarboxylic acid derivatives, for example

ethyl 2-(4-(3,5-dichloropyridyl-2-oxy)phenoxy)propionate (EP-A-0002925),

propargyl 2-(4-(3,5-dichloropyridyl-2-oxy)phenoxy)propionate (EP-A-0003114),

methyl 2-(4-(3-chloro-5-trifluoromethyl-2-pyridyloxy)phenoxy)propionate (EP-A-0003890),

ethyl 2-(4-(3-chloro-5-trifluoromethyl-2-pyridyloxy)phenoxy)propionate (EP-A-0003890),

propargyl 2-(4-(5-chloro-3-fluoro-2-pyridyloxy)phenoxy)propionate (EP-A-0191736),

butyl 2-(4-(5-trifluoromethyl-2-pyridyloxy)phenoxy)propionate (fluazifop-butyl);

A3) “bicyclic” heteroaryloxyphenoxyalkanecarboxylic acid derivatives, for example

methyl and ethyl 2-(4-(6-chloro-2-quinoxalyloxy)phenoxy)propionate (quizalofopmethyl and quizalofopethyl),

methyl 2-(4-(6-fluoro-2-quinoxalyloxy)phenoxy)propionate (see J. Pest. Sci. Vol. 10, 61 (1985)),

2-isopropylideneaminooxyethyl 2-(4-(6-chloro-2-quinoxalyloxy)phenoxy)propionate (propaquizafop),

ethyl 2-(4-(6-chlorobenzoxazol-2-yloxy)phenoxy)propionate (fenoxaprop-ethyl), its D(+) isomer (fenoxaprop-P-ethyl EX) and ethyl 2-(4-(6-chlorobenzothiazol-2-yloxy)-phenoxy)propionate (DE-A-2640730),

tetrahydro-2-furylmethyl 2-(4-(6-chloroquinoxalyloxy)phenoxy)propionate (EP-A-0323727);

A4) phenoxycarboxylic acid derivatives, such as 2,4-D, 2,4-DP, 2,4-DB, CMPP and MCPA and their esters and salts;

B) chloroacetanilides, for example

N-methoxymethyl-2,6-diethyl-chloroacetanilide (alachlor),

N-(3-methoxyprop-2-yl)-2-methyl-6-ethylchloroacetanilide (metolachlor),

2,6-dimethyl-N-(3-methyl-1,2,4-oxadiazol-5-ylmethyl)chloroacetanilide,

N-(2,6-dimethylphenyl)-N-(1-pyrazolylmethyl)chloroacetamide (metazachlor);

C) thiocarbamates, for example

S-ethyl N,N-dipropylthiocarbamate (EPTC),

S-ethyl N,N-diisobutylthiocarbamate (butylate);

D) cyclohexanedione oximes, for example

methyl 3-(1-allyloxyiminobutyl)-4-hydroxy-6,6-dimethyl-2-oxocyclohex-3-ene-carboxylate (alloxydim),

2-(1-ethoxyiminobutyl)-5-(2-ethylthiopropyl)-3-hydroxycyclohex-2-ene-1-one (sethoxydim),

2-(1-ethoxyiminobutyl)-5-(2-phenylthiopropyl)-3-hydroxycyclohex-2-ene-1-one (cloproxydim),

2-(1-(3-chloroallyloxy)iminobutyl)-5-(2-ethylthiopropyl)-3-hydroxycyclohex-2-ene-1-one,

2-(1-(3-chloroallyloxy)iminopropyl)-5-(2-ethylthiopropyl)-3-hydroxycyclohex-2-ene-1-one (clethodim),

2-(1-ethoxyiminobutyl)-3-hydroxy-5-(thian-3-yl)cyclohex-2-enone (cycloxydim),

2-(1-ethoxyiminopropyl)-5-(2,4,6-trimethylphenyl)-3-hydroxycyclohex-2-ene-1-one (tralkoxydim);

E) benzoylcyclohexanediones, for example

2-(2-chloro-4-methylsulfonylbenzoyl)cyclohexane-1,3-dione (SC-0051, EP-A-0137963), 2-(2-nitrobenzoyl)-4,4-dimethylcyclohexane-1,3-dione (EP-A-0274634), 2-(2-nitro-4-methylsulfonylbenzoyl)-4,4-dimethylcyclohexane-1,3-dione (WO-A-91/13548 mesotrione);

F) S-(N-aryl-N-alkylcarbamoylmethyl) dithiophosphonates, such as S-[N-(4-chlorophenyl)-N-isopropylcarbamoylmethyl] O,O-dimethyl dithiophosphate (anilophos);

G) alkylazines, such as, for example, described in WO-A-97/08156, WO-A-97/31904, DE-A-19826670, WO-A-98/15536, WO-A-98/15537, WO-A-98/15538, WO-A-98/15539 and also DE-A-19828519, WO-A-98/34925, WO-A-98/42684, WO-A-99/188100, WO-A-99/19309, WO-A-99/37627 and WO-A-99/65882, preferably those of the formula (G) 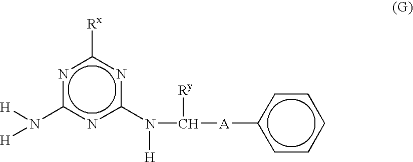
in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—,
   particularly preferably those of the formulae G1-G7 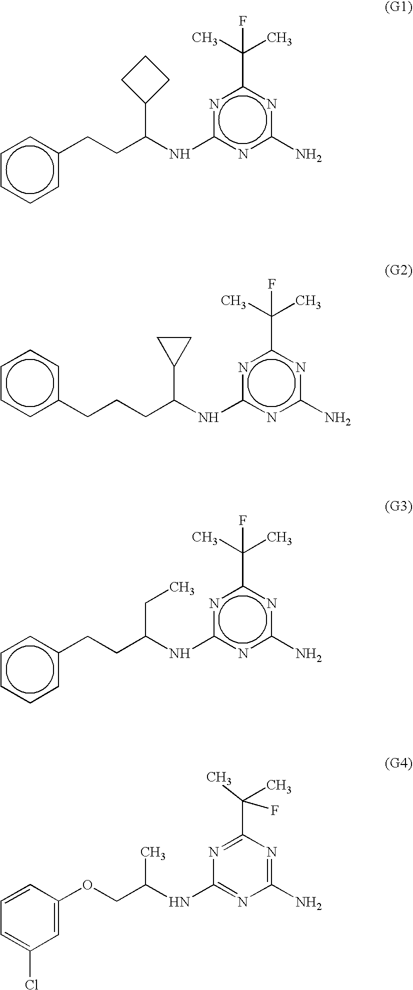 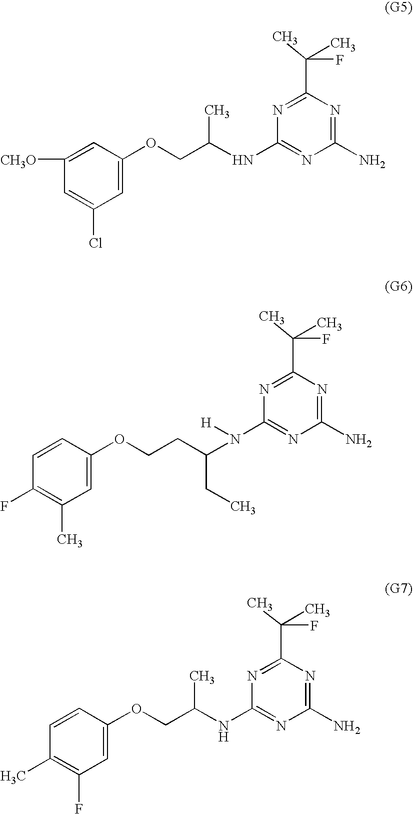
   H) Phosphorus-containing herbicides, for example of the glusosinate type, such as glufosinate in a narrower sense, i.e. D,L-2-amino-4-[hydroxy(methyl)phosphinyl]-butanoic acid, glufosinate monoammonium salt, L-glufosinate, L- or (2S)-2-amino-4-[hydroxy(methyl)phosphinyl]butanoic acid L-glufosinate monoammonium salt or bialaphos (or bilanafos), i.e. L-2-amino-4-[hydroxy(methyl)phosphinyl]butanoyl-L-alanyl-L-alanine, in particular its sodium salt,
   or of the glyphosate type, such as glyphosate, i.e. N-(phosphonomethyl)glycine, glyphosate monoisopropylammonium salt, glyphosate sodium salt or sulfosate, i.e. N-(phosphonomethyl)glycine trimesium salt=N-(phosphonomethyl)glycine trimethylsulfoxonium salt.

Also to be mentioned here are imidazolinones, pyrimidinyloxypyridinecarboxylic acid derivatives, pyrimidyloxybenzoic acid derivatives, triazolopyrimidinesulfonamide derivatives with typical representatives such as, for example, diflufenican, bromoxynil-comprising or ioxynil-comprising products, herbicides from the class of the oxyacetamides, such as flufenacet, herbicides from the class of the aryloxyphenoxypropionates, such as fenoxaprop-p-ethyl, beet herbicides, such as desmedipham, phenmedipham, ethofumesate or metamitron, or else active compounds of the class of the HPPD inhibitors (for example isoxaflutole, sulcotrione, mesotrione), especially, for example:

I) imidazolinones, for example methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz), 5-ethyl-2-(4-isopropyl-4-methyl-5-oxo-2-imidazolin-2-yl)-pyridine-3-carboxylic acid (imazethapyr), 2-(4-isopropyl-4-methyl-5-oxo-2-imidazolin-2-yl)quinoline-3-carboxylic acid (imazaquin), 2-(4-isopropyl-4-methyl-5-oxo-2-imidazolin-2-yl)pyridine-3-carboxylic acid (imazapyr), 5-methyl-2-(4-isopropyl-4-methyl-5-oxo-2-imidazolin-2-yl)pyridine-3-carboxylic acid (imazethamethapyr);

J) triazolopyrimidinesulfonamide derivatives, for example N-(2,6-difluorophenyl)-7-methyl-1,2,4-triazolo[1,5-c]pyrimidine-2-sulfonamide (flumetsulam), N-(2,6-dichloro-3-methylphenyl)-5,7-dimethoxy-1,2,4-triazolo[1,5-c]pyrimidine-2-sulfonamide, N-(2,6-difluorophenyl)-7-fluoro-5-methoxy-1,2,4-triazolo[1,5-c]pyrimidine-2-sulfonamide, N-(2,6-dichloro-3-methylphenyl)-7-chloro-5-methoxy-1,2,4-triazolo[1,5-c]pyrimidine-2-sulfonamide, N-(2-chloro-6-methoxycarbonyl)-5,7-dimethyl-1,2,4-triazolo[1,5-c]pyrimidine-2-sulfonamide (EP-A-0343752, U.S. Pat. No. 4,988,812);

K) pyrimidinyloxypyridinecarboxylic acid or pyrimidinyloxybenzoic acid derivatives, for example benzyl 3-(4,6-dimethoxypyrimidin-2-yl)oxypyridine-2-carboxylate (EP-A-0249707), methyl 3-(4,6-dimethoxypyrimidin-2-yl)oxypyridine-2-carboxylate (EP-A-0249707), 2,6-bis[(4,6-dimethoxypyrimidin-2-yl)oxy]benzoic acid (EP-A-0321846), 1-ethoxycarbonyloxyethyl 2,6-bis[(4,6-dimethoxypyrimidin-2-yl)oxy]benzoate (EP-A-0472113).

L) sulfonamides and salts thereof which are not included in the scope of the formula (I) (component a). Mention may be made of representatives from the group of the phenylsulfonylureas, such as iodosulfuron-methyl and its sodium salt (iodosulfuron-methyl-sodium) and mesosulfuron-methyl and its sodium salt, and also representatives from the group of the other sulfonamides, such as amidosulfuron and its sodium salt (amidosulfuron-methyl-sodium).

The herbicides of groups A to L are known, for example, from the above-mentioned publications and from “The Pesticide Manual”, 12th edition, (2000) and 13th edition (2003), The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA, 1990.

Suitable agrochemically active compounds (component f) (which are different from components (a) and (c) and may or may not be present) for the formulations according to the invention are, for example, the known active compounds listed below, as described, for example, in Weed Research 26, 441-445 (1986), or in “The Pesticide Manual”, 12th edition (2000) and 13th edition (2003), The British Crop Protection Council, and the literature cited therein, for example in formulated mixtures or as components for tank mixes. The compounds are referred to either by the “common name” according to the International Organization for Standardization (ISO) or by the chemical name, if appropriate together with a customary code number, and include in each case all use forms, such as acids, salts, esters and isomers, such as stereoisomers and optical isomers: acetochlor; acifluorfen; aclonifen; AKH 7088, i.e. [[[1-[5-[2-chloro-4-(trifluoromethyl)phenoxy]-2-nitrophenyl]-2-methoxyethylidene]amino]oxy]acetic acid and methyl [[[1-[5-[2-chloro-4-(trifluoromethyl)phenoxy]-2-nitrophenyl]-2-methoxyethylidene]amino]oxy]acetate; alachlor; alloxydim; ametryn; amitrol; AMS, i.e. ammonium sulfamate; anilofos; asulam; atrazine; azafenidine (DPX-R6447); aziprotryn; barban; BAS 516H, i.e. 5-fluoro-2-phenyl-4H-3,1-benzoxazin-4-one; benazolin; benfluralin; benfuresate; bensulide; bentazone; benzofluor; benzoylprop-ethyl; benzthiazuron; bialaphos; bifenox; bispyribac-sodium (KIH-2023), bromacil; bromobutide; bromofenoxim; bromoxynil, in particular bromoxynil-octanoate and bromoxynil-heptanoate; butachlor; butamifos; butenachlor; buthidazole; butralin; butroxydim (ICI-0500), butylate; cafenstrole (CH-900); carbetamide; cafentrazone; CDM, i.e. 2-chloro-N,N-di-2-propenylacetamide; CDEC, i.e. 2-chloroallyl diethyldithiocarbamate; chlomethoxyfen; chloramben; cloransulam-methyl (XDE-565), chlorazifop-butyl, chlorbromuron; chlorbufam; chlorfenac; chlorflurenol-methyl; chloridazon; chlornitrofen; chlorotoluron; chloroxuron; chlorpropham; chlorthal-dimethyl; chlorthiamid; cinidonethyl, cinmethylin; clethodim; clodinafop and its ester derivatives (for example clodinafop-propargyl); clomazone; clomeprop; cloproxydim; clopyralid; cumyluron (JC 940); cyanazine; cycloate; cycloxydim; cycluron; cyhalofop and its ester derivatives (for example the butyl ester, DEH-112); cyperquat; cyprazine; cyprazole; 2,4-D; 2,4-DB; dalapon; desmedipham; desmetryn; di-allate; dicamba; dichlobenil; dichlorprop; diclofop and its esters, such as diclofop-methyl; diclosulam (XDE-564), diethatyl; difenoxuron; difenzoquat; diflufenican; diflufenzopyr-sodium (SAN-835H), dimefuron; dimethachlor; dimethametryn; dimethenamid (SAN-582H); dimidazone, methyl 5-(4,6-dimethylpyrimidin-2-ylcarbamoylsulfamoyl)-1-(2-pyridyl)pyrazole-4-carboxylate (NC-330); triaziflam (IDH-1105), cinosulfon; dimethipin, dinitramine; dinoseb; dinoterb; diphenamid; dipropetryn; diquat; dithiopyr; diuron; DNOC; eglinazine-ethyl; EL 177, i.e. 5-cyano-1-(1,1-dimethylethyl)-N-methyl-1H-pyrazole-4-carboxamide; endothal; indanofan (MK-243), EPTC; esprocarb; ethalfluralin; ethidimuron; ethiozin; ethofumesate; F5231, i.e. N-[2-chloro-4-fluoro-5-[4-(3-fluoropropyl)-4,5-dihydro-5-oxo-1H-tetrazol-1-yl]phenyl]ethanesulfonamide; ethoxyfen and its esters (for example the ethyl ester, HN-252); etobenzanid (HW 52); 3-(4-ethoxy-6-ethyl-1,3,5-triazin-2-yl)-1-(2,3-dihydro-1,1-dioxo-2-methylbenzo[b]thiophene-7-sulfonyl)urea (EP-A 079 683); 3-(4-ethyl-6-methoxy-1,3,5-triazin-2-yl)-1-(2,3-di-hydro-1,1-dioxo-2-methylbenzo[b]thiophene-7-sulfonyl)urea (EP-A-079683); fenoprop; clomazone, fenoxaprop and fenoxaprop-P and their esters, for example fenoxaprop-P-ethyl and fenoxaprop-ethyl; butroxydimfenuron; flamprop-methyl; flufenacet (BAY-FOE-5043), fluazifop and fluazifop-P and their esters, for example fluazifop-butyl and fluazifop-P-butyl, florasulam (DE-570); fluchloralin; flumetsulam; fluometuron; flumiclorac and its esters (for example the pentyl ester, S-23031); flumioxazin (S-482); flumipropyn; flupoxam (KNW-739); fluorodifen; fluoroglycofen-ethyl; flupropacil (UBIC-4243); fluridone; flurochloridone; fluroxypyr; flurtamone; fluthiacet-methyl (KIH-9201), fomesafen; fosamine; furyloxyfen; glufosinate; glyphosate; halosafen; haloxyfop and its esters; haloxyfop-P (═R-haloxyfop) and its esters; hexazinone; imazamethabenz-methyl; imazamox (AC-299263), imazapyr; imazaquin and salts thereof, such as the ammonium salt; imazapic; imazethapyr; ioxynil; isocarbamid; isopropalin; isoproturon; isouron; isoxaben; isoxapyrifop; karbutilate; lactofen; lenacil; linuron; MCPA; MCPB; mecoprop; mefenacet; mefluidid; metamitron; metazachlor; methabenzthiazuron; metam; methazole; methoxyphenone; methyldymron; metobenzuron, metobromuron; metolachlor; S-metolachlor, metosulam (XRD 511); metoxuron; metribuzin; maleic hydrazide; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazole; neburon; nipyraclophen; nitralin; nitrofen; nitrofluorfen; norflurazon; orbencarb; oryzalin; oxadiargyl (RP-020630); oxadiazon; oxaziclomefone (MY-100), oxyfluorfen; paraquat; pebulate; pendimethalin; pentoxazone (KPP-314), perfluidone; phenisopham; phenmedipham; picloram; piperophos; pyributicarb; pirifenop-butyl; pretilachlor; procyazine; prodiamine; profluralin; proglinazine-ethyl; prometon; prometryn; propachlor; propanil; propaquizafop and its esters; propazine; propham; propisochlor; propyzamide; prosulfalin; prosulfocarb; prynachlor; pyraflufen-ethyl (ET-751), chloridazon; pyrazoxyfen; pyribenzoxim, pyridate; pyriminobac-methyl (KIH-6127), pyrithiobac (KIH-2031); pyroxofop and its esters (for example the propargyl ester); quinclorac; quinmerac; quizalofop, quizalofop and quizalofop-P and their ester derivatives, for example quizalofop-ethyl; quizalofop-P-tefuryl and -ethyl; S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; SN 106279, i.e. 2-[[7-[2-chloro-4-(trifluoromethyl)phenoxy]-2-naphthalenyl]oxy]propanoic acid and methyl 2-[[7-[2-chloro-4-(trifluoromethyl)phenoxy]-2-naphthalenyl]oxy]propanoate; sulfazuron; glyphosatetrimesium (ICI-A0224); TCA; tebutam (GCP-5544); tebuthiuron; tepraloxydim (BAS-620H), terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiazafluron; thiazopyr (Mon-13200); thidiazimin (SN-124085); thiobencarb; tiocarbazil; tralkoxydim; tri-allate; triazofenamide; triclopyr; tridiphane; trietazine; trifluralin; trimeturon; tsitodef; vernolate; WL 110547, i.e. 5-phenoxy-1-[3-(trifluoromethyl)phenyl]-1H-tetrazole; UBH-509; D-489; LS 82-556; KPP-300; KPP-421, MT-146, NC-324; butenachlor (KH-218); DPX-N8189; haloxyfop-etotyl (DOWCO-535); DK-8910; flumioxazin (V-53482); PP-600; MBH-001, amicarbazone, aminopyralid, beflubutamid, benzobicyclon, benzofenap, benzfendizone, butafenacil, chlorfenprop, cloprop, daimuron, dichlorprop-P, dimepipeate, dimethenamid-P, fentrazamide, flamprop-M, fluazolate, indanofan, isoxachlortole, isoxaflutole, MCPA-thioethyl, mecoprop-P, mesotrione, metamifop, penoxsulam, pethoxamid, picolinafen, profluazol, profoxydim, pyraclonil, pyrazolynate, pyridafol, pyriftalid, sulcotrione, thidiazuron, iodosulfuron-methyl, iodosulfuron-methyl-sodium, mesosulfuron-methyl, mesosulfuron-methyl-sodium, amidosulfuron, amidosulfuron-sodium.

The proportion of the agrochemically active compounds (component f) which are different from components (a) and (b) and which may optionally be present in the formulations according to the invention may be 0.05-70% by weight, preferably 0.1-20% by weight, particularly preferably 0.3-10% by weight, very particularly preferably 0.5-5% by weight.

As optional further customary auxiliaries and additives (component g), the formulations may comprise, for example, auxiliaries and additives different from component (e) and selected from the groups of the disintegrants, binders (tackifiers), agents for adjusting the pH and the like.

Suitable disintegrants may be chosen from the group of the modified carbohydrates, such as microcrystalline cellulose, and crosslinked polyvinylpyrrolidones.

Typical representatives of suitable disintegrants are, inter alia, ®Avicel PH 101 (microcrystalline cellulose), ®Agrimer XLF (crosslinked polyvinylpyrrolidone), ®Disintex 200 (crosslinked polyvinylpyrrolidone).

Preference is given to crosslinked polyvinylpyrrolidones, such as ®Agrimer XLF. The proportion of disintegrants which may optionally be present in the formulations according to the invention may be 0.1-50% by weight, preferably 0.5-25% by weight, particularly preferably 1-10% by weight.

Suitable binders (tackifiers) may be selected from the group consisting of polyvinylpyrrolidone (PVP), polyvinyl alcohol, the copolymer of PVP and dimethylaminoethyl methacrylate, butylated PVP, the copolymer of vinyl chloride and vinyl acetate, the Na salt of the copolymer of propenesulfonic acid and partially hydrolyzed vinyl acetate, sodium caseinate, phenol resins, modified cellulose types. Typical representatives of suitable binders are, inter alia, ®Luviskol (polyvinylpyrrolidone), ®Mowiol (polyvinyl alcohol), ®Tylose (modified cellulose). Preference is given to polyvinylpyrrolidone types, particular preference is given to types of low molecular weight, such as ®Luviskol K30.

The proportion of binders which may optionally be present in the formulations according to the invention may be 0.5-20% by weight, preferably 1-10% by weight, particularly preferably 3-8% by weight.

Suitable agents for adjusting the pH may be selected from the group of the hydroxides and carbonates of alkali metals and alkaline earth metals.

Typical representatives of suitable agents for adjusting the pH are, inter alia, NaOH, KOH, Na₂CO₃ and K₂CO₃.

Preference is given to NaOH and Na₂CO.

The proportion of agents for adjusting the pH which may optionally be present in the formulations according to the invention may be 0.01-5% by weight, preferably 0.05-3% by weight, particularly preferably 0.1-2% by weight.

A particularly preferred embodiment of the invention comprises (where commercial products and their proportions are mentioned by way of example)
(a) phenylsulfonylurea, such as, for example, metsulfuron-methyl with 6.75% by weight, and
(b) a safener, such as, for example, mefenpyr-diethyl with 9% by weight;
(c) a solvent, such as, for example, ®Solvesso 200ND with 15.25% by weight;
(d) a plurality of carrier materials selected from the following groups:
   (d-1) carriers with low absorbency, such as, for example, ®Harborlite 300 with 5% by weight and ®Kaolin 1777 with 18.99% by weight, and
   (d-2) carriers with high absorbency, such as, for example, ®Sipernat 50S with 12% by weight;
(e) a plurality of customary auxiliaries and additives selected from the following groups:
   (e-1) emulsifiers, such as, for example, ®Calsogen AR100 ND (anionic) with 2.63% by weight and ®Emulsogen 3510 (nonionic) with 1.5% by weight,
   (e-2) antifoams, such as, for example, ®Antischaum-Mittel SE 2 with 1% by weight,
   (e-3) wetting agents, such as, for example, ®Synperonic T/905 with 6% by weight,
   (e-4) dispersants, such as, for example, ®Morwet D425 with 10% by weight;
(f) a further active compound from the group of the sulfonamides and their salts which are not included in the scope of the formula (I) (component a), such as, for example, mesosulfuron-methyl with 4.5% by weight;
(g) a plurality of further auxiliaries and additives different from component (e), selected from the following groups:

binders, such as, for example, ®Luviskol K30 with 5% by weight, and agents for adjusting the pH, such as, for example, Na hydroxide (NaOH, 100% pure) with 0.38% by weight,

and a remaining residual moisture of, for example, 2% by weight,

where

the ratio of component (b) to component (c) is 0.6 (b):1 (c) and at the same time the ratio of the sum of components (b) and (c) to component (d-2) is: 2 [(b)+(c)]:1 (d-2).

A particularly preferred embodiment of the invention comprises (where commercial products and their proportions are mentioned by way of example)
(a) phenylsulfonylurea, such as, for example, metsulfuron-methyl with 11.25% by weight, and
(b) a safener, such as, for example, mefenpyr-diethyl with 9% by weight;
(c) a solvent, such as, for example, ®Solvesso 200ND with 15.25% by weight;
(d) a plurality of carrier materials selected from the following groups:
   (d-1) carriers with low absorbency, such as, for example, ®Harborlite 300 with 5% by weight and ®Kaolin 1777 with 18.99% by weight, and
   (d-2) carriers with high absorbency, such as, for example, ®Sipernat 50S with 12% by weight;
(e) a plurality of customary auxiliaries and additives selected from the following groups:
   (e-1) emulsifiers, such as, for example, ®Calsogen AR100 ND (anionic) with 2.63% by weight and ®Emulsogen 3510 (nonionic) with 1.5% by weight,
   (e-2) antifoams, such as, for example, ®Antischaum-Mittel SE 2 with 1% by weight,
   (e-3) wetting agents, such as, for example, ®Synperonic T/905 with 6% by weight,
   (e-4) dispersants, such as, for example, ®Morwet D425 with 10% by weight;
(g) a plurality of further auxiliaries and additives different from component (e), selected from the following groups:
binders, such as, for example, ®Luviskol K30 with 5% by weight, and agents for adjusting the pH, such as, for example, Na hydroxide (NaOH, 100% pure) with 0.38% by weight,
   and a remaining residual moisture of, for example, 2% by weight,
   where
   the ratio of component (b) to component (c) is 0.6 (b):1 (c) and at the same time the ratio of the sum of components (b) and (c) to component (d-2) is: 2 [(b)+(c)]:1 (d-2).

The invention furthermore relates to a herbicidal composition which may be prepared from the formulations according to the invention by dilution with liquids, preferably water.

For application purposes, the formulations according to the invention may optionally be diluted in the usual way, for example using water, to give, for example, suspensions, emulsions, suspoemulsions or solutions. It may be advantageous to add to the herbicidal compositions (sprays) obtained in this manner further active compounds, preferably agrochemically active compounds (for example as tank mixing partners in the form of corresponding formulations) and/or auxiliaries and additives customary for application, for example adjuvants such as, for example, self-emulsifying oils, such as vegetable oils or paraffin oils, and/or fertilizers. Accordingly, the present invention also relates to the herbicidal compositions prepared in this manner.

The herbicidal composition (spray liquor) per ha is usually from 50 to 1500 liters, preferably from 50 to 500 liters, particularly preferably from 75 to 350 liters, of water. In some cases, the actual values may also be lower or higher than the limits given here.

The formulations are also suitable for application by plane. To this end, the formulations according to the invention are applied either in undiluted form, diluted with water or diluted with organic solvents. In this case, the volume of additional carrier liquid generally varies between 0.5-50 liters per hectare.

The application rate of the formulations according to the invention per hectare generally varies and depends on each individual active compound from the group of the sulfonamides of the formula (I) and their salts (component a) in the combinations in question. With respect to the entire formulation according to the invention, it is generally from 5 g to 5 kg of solid water-dispersible formulation per hectare, preferably from 25 g to 2.5 kg, particularly preferably from 25 g to 1.5 kg, very particularly preferably from 50 g to 1.5 kg and especially preferably from 50 g to 500 g; and with respect to component (a) generally from 0.5 g to 200 g of active compound per hectare, preferably from 1.0 g to 100 g, particularly preferably from 1.0 g to 75 g, where in individual cases the actual values may also be lower or higher than the limits given here.

A particular embodiment of the invention relates to the use of the herbicidal compositions, obtainable from the formulations according to the invention, for controlling unwanted vegetation (harmful plants), hereinbelow referred to as “herbicidal composition”, with simultaneous excellent crop compatibility, i.e. high selectivity.

The herbicidal compositions have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the herbicidal compositions are applied before sowing, pre-emergence or post-emergence. Specific examples may be mentioned of some representatives of the monocotyledonous and dicotyledonous weed flora which can be controlled by the herbicidal compositions, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The compositions according to the invention also act outstandingly efficiently on harmful plants which are found under the specific cultures in rice, such as, for example, Echinochloa, Sagittaria, Alisma, Eleocharis, Scirpus and Cyperus.

If the herbicidal compositions are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions are distinguished by a rapidly commencing and long-lasting herbicidal action. As a rule, the rainfastness of the active substances in the herbicidal compositions is advantageous. A particular advantage is that the dosages used in the herbicidal compositions and the effective dosages of herbicidal compounds can be adjusted to such a low level that their soil action is optimally low. This does not only allow them to be employed in sensitive crops in the first place, but groundwater contaminations are virtually avoided. The active compound combination according to the invention allows the required application rate of the active substances to be reduced considerably.

The abovementioned properties and advantages are necessary for weed control practice to keep agricultural crops free from undesired competing plants, and thus to ensure and/or increase yield levels from the qualitative and quantitative angle. These novel herbicidal compositions markedly exceed the technical state of the art with a view to the properties described.

While the herbicidal compositions have an outstanding herbicidal activity against monocotyledonous and dicotyledonous weeds, crop plants of economically important crops, for example dicotyledonous crops such as soya, cotton, oilseed rape, sugarbeet, or graminaceous crops such as wheat, barley, rye, oats, millet, rice or corn, are damaged only to a minor extent, if at all. This is why the present herbicidal compositions are highly suitable for the selective control of undesired plant growth in plantations of agricultural crops or of ornamentals.

In addition, the corresponding herbicidal compositions have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

Owing to their herbicidal and plant-growth-regulatory properties, the herbicidal compositions can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the herbicidal compositions in economically important transgenic crops of useful plants and omamentals, for example of graminaceous crops such as wheat, barley, rye, oats, millet, rice and corn, or else crops of sugarbeet, cotton, soya, oilseed rape, potatoes, tomatoes, peas and other vegetables, is preferred. Preferably, the herbicidal compositions can be employed in crops of useful plants which resist the phytotoxic effects of the herbicides, or have been made to resist these effects by recombinant techniques.

When using the herbicidal compositions in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the further herbicidally active compounds to which the transgenic crop is resistant, and an effect on growth and yield level of the transgenic crop plants.

The present invention therefore also relates to a method for controlling undesired vegetation (harmful plants), preferably in crops of plants such as cereals (for example wheat, barley, rye, oats, rice, corn and millet), sugar beet, sugar cane, oilseed rape, cotton and soya, especially preferred in monocotyledonous plants such as cereals, for example wheat, barley, rye, oats, and their hybrids such as triticale, rice, corn and millet, wherein the herbicidal compositions according to the invention are applied to the harmful plants, plant parts, seeds of the plants or the area on which the plants grow, for example the area under cultivation.

The plant crops may also be genetically modified or have been obtained by mutation selection; they preferably tolerate acetolactate synthase (ALS) inhibitors.

The process for preparing the formulations according to the invention can be selected from a number of processes known per se which permit the preparation of solid formulations, such as water-dispersible powders (WP), granules (WG), and compacted products preparable therefrom, such as flakes, tablets, etc. From among these processes, preference is given to extrusion, pan and fluidized bed granulation, particularly preferably fluidized bed granulation. Common to all processes is that the individual components are combined in the respective ratios, as a result of the preparation.

Compared to commercial products, the formulations according to the invention have a significantly improved application behavior which is noticeable in considerably reduced sieve residues and/or sieve or nozzle blockages.

The formulations according to the invention also have excellent chemical stability during preparation and storage and are suitable in particular also for combinations of active compounds having different physicochemical properties. The formulations according to the invention likewise have excellent physical stability, are easy to use and have high biological effectiveness and selectivity.

The pH for the formulations according to the invention, for example in 10% strength aqueous solution, is generally between 7 and 9.

Altogether, the formulations according to the invention have the desired long-term storage stability and can be applied without any problems.

### EXAMPLES

The examples serve to illustrate the invention and do not limit the processes and compounds described therein.

Preparation Process:

The safeners (component b) are, together with the solvents (component c) and, if appropriate, emulsifiers (component e-1), applied to the carrier material (component d-2), whereupon a flowable absorbate is produced. This is then mixed with the other formulation components at the particular ratios. The mixture formed is then, using an air jet mill, ground finely and then moistened with about 5% water. This moistened material is subjected to extrusion granulation using a dome extruder, for example a perforated dome having perforations of the width of 0.5-0.8 mm. The moist granules are then air-dried until their residual water content corresponds to the value defined beforehand. The examples shown in tables 1 and 2 comprise a residual water content of about≦2% by weight.

Description of the commercial products used in the text and the examples:

| | |
|---|---|
| Metsulfuron-methyl | Active compound (phenylsulfonylurea), Du Pont |
| Metsulfuron-methyl- | Active compound (phenylsulfonylurea sodium salt), |
| sodium | Du Pont; salt prepared by processes known to |
| | the person skilled in the art from |
| | metsulfuron-methyl. |
| Iodosulfuron- | Active compound (phenylsulfonylureas), Bayer |
| methyl-sodium 91% | CropScience |
| Mesosulfuron- | Active compound (phenylsulfonylureas), Bayer |
| methyl 95% | CropScience |
| ®Kaolin Tec 1/ | Carrier material, low absorbency (kaolin, aluminum |
| 1777 | hydrosilicate), inter alia Ziegler & Co. |
| ®Harborlite 300 | Carrier material, low absorbency (perlite), |
| | Lehmann & Voss |
| ®Aerosol OTB | Wetting agent of the sulfosuccinic acid derivative |
| | type (Na diisooctylsulfosuccinate), Cytec - |
| | analogous to ®Newkalgen EX-70 and ®Geropon |
| | SDS from EP-A-764404 |
| ®Morwet D425 | Dispersant (condensate of naphthalenesulfonic |
| | acid and formaldehyde), Akzo Nobel |
| ®Luviskol K30 | Binder (polyvinylpyrrolidone), BASF |
| ®Wacker ASP 15 | Antifoam emulsifier, anionic (polydimethylsiloxane, |
| | absorbed on a solid carrier), Wacker |
| Mefenpyr-diethyl | Safener (dichlorophenylpyrazoline-3-carboxylic |
| 94% | acid), Bayer CropScience |
| ®Solvesso 200ND | Aromatic solvent (alkylated naphthalene), Exxon |
| ®Calsogen AR100 | Emulsifier, anionic (Ca dodecylbenzenesulfonate), |
| | Clariant |
| ®Emulsogen 3510 | Emulsifier, nonionic (alkylated EO/PO |
| | block copolymer), Clariant |
| ®Sipernat 50S | Carrier material, high absorbency (precipitated |
| | silicic acid), Degussa |

Test method for determining the dispersibility of solid water-dispersible formulations (WG):

The sample (about 1.5 g of WG) is added to a measuring cylinder containing 100 ml of CIPAC standard water D (=342 ppm) of room temperature. The cylinder is closed and immediately inverted by 180 degrees and returned into its original position (within a period of about 2 seconds). It is then examined visually whether the dispersion is complete. In each case after about 4 seconds, the procedure is repeated, until no undispersed material remains. The maximum number of cylinder inversions in this test method is 30. If the sample is not completely dispersed after this number of inversions, the test is terminated and the dispersibility is considered to be negative (dispersibility: NO).

TABLE 1
Examples 1 (prior art) and 2 (according to the invention)

| | | | Example 2/ |
|---|---|---|---|
| | | Example 1/ | according to |
| | | prior art | the invention |
| Component | Name | [% by weight] | [% by weight] |
| (a) | metsulfuron-methyl- | 16.80 | 16.80 |
| | sodium | | |
| (b) | mefenpyr-diethyl 94% | 8.00 | 8.00 |
| (c) | ®Solvesso 200ND | — | 8.37 |
| (d-1) | ®Kaolin Tec 1 | 42.18 | 32.52 |
| (d-2) | ®Sipernat 50S | 6.02 | 6.02 |
| (e-1) | ®Emulsogen 3510 | — | 0.76 |
| (e-1) | Ca | — | 0.53 |
| | dodecylphenylsulfonate | | |
| (e-2) | ®Wacker ASP 15 | 1.00 | 1.00 |
| (e-3) | ®Aerosol OTB | 5.00 | 5.00 |
| (e-4) | ®Morwet D425 | 15.00 | 15.00 |
| (f) | iodosulfuron-methyl- | 1.00 | 1.00 |
| | sodium 91% | | |
| (g) | ®Luviskol K30 | 5.00 | 5.00 |
| | (binder) | | |

| | | |
|---|---|---|
| Dispersibility (according to the | NO | YES |
| test method described above) | | |

Note:
Table 1 shows the composition of solid water-dispersible formulations, Example 1 having a standard composition corresponding to the prior art and Example 2 showing the composition according to the invention.

The result of the test method for determining the dispersibility shows clearly that only the composition of the formulation according to the invention (Example 2) has sufficient dispersibility (dispersibility: YES).

TABLE 2
Examples 3 (prior art) and 4 (according to the invention)

| | | Example 3/ | Example 4/ |
|---|---|---|---|
| | | piror art | according to the |
| | | [% | invention |
| Component | Name | by weight] | [% by weight] |
| (a) | metsulfuron-methyl- | 17.80 | 17.80 |
| | sodium | | |
| (b) | mefenpyr-diethyl 94% | 8.00 | 8.00 |
| (c) | ®Solvesso 200ND | — | 8.37 |
| (d-1) | ®Kaolin Tec 1 | 42.18 | 32.52 |
| (d-2) | ®Sipernat 50S | 6.02 | 6.02 |
| (e-1) | ®Emulsogen 3510 | — | 0.76 |
| (e-1) | dodecylphenylsulfonate | — | 0.53 |
| | Ca | | |
| (e-2) | ®Wacker ASP 15 | 1.00 | 1.00 |
| (e-3) | ®Aerosol OTB | 5.00 | 5.00 |
| (e-4) | ®Morwet D425 | 15.00 | 15.00 |
| (g) | ®Luviskol K30 (binder) | 5.00 | 5.00 |

| | | |
|---|---|---|
| Dispersibility (according to the | NO | YES |
| test method described above) | | |

Note:
Table 2 shows the composition of solid water-dispersible formulations, Example 3 having a standard composition corresponding to the prior art and Example 4 showing the composition according to the invention.

The result of the test method for determining the dispersibility shows clearly that only the composition of the formulation according to the invention (Example 4) has sufficient dispersibility (dispersibility: YES).

1. A solid water-dispersible formulation comprising:
(a) one or more active compounds from the group of the sulfonamides of the formula (I) and their salts,
(b) one or more safeners,
(c) one or more solvents,
(d) one or more carrier materials, selected from one or more of the following groups:
(d-1) carriers with low absorbency,
(d-2) carriers with high absorbency;
(e) one or more customary auxiliaries and additives, selected from one or more of the following groups
(e-1) emulsifiers,
(e-2) antifoams,
(e-3) wetting agents,
(e-4) dispersants;
where
component (b) to component (c) is in the following ratio: (b):(c) in general from 0.3 to 2.0:1, preferably from 0.4 to 1.5:1, particularly preferably from 0.5 to 1.0:1; and
where at the same time the sum of components (b) and (c) to component (d-2) is in the following ratio: [(b)+(c)]:(d-2) in general from 1.7 to 3.9:1, preferably from 1.85 to 3.5:1, particularly preferably from 2.0 to 3.0:1.

2. The solid water-dispersible formulation as claimed in claim 1 which comprises, as component (a), herbicidally active compounds from the group of the phenylsulfonamides, such as phenylsulfonylureas and heteroarylsulfonylureas, and also their salts.

3. The solid water-dispersible formulation as claimed in claim 1 which comprises, as component (a), active compounds from the group consisting of azimsulfuron and its salts, such as the sodium salt, bensulfuron-methyl, chlorimuron-ethyl, chlorsulfuron, ethametsulfuron-methyl, flupyrsulfuron-methyl and its salts, such as the sodium salt, metsulfuron-methyl, nicosulfuron and its salts, such as the sodium salt, rimsulfuron and its salts, such as the sodium salt, sulfometuron-methyl, thifensulfuron-methyl and its salts, such as the sodium salt, tribenuron-methyl, triflusulfuron-methyl, methyl 4-[(4,5-dihydro-3-methoxy-4-methyl-5-oxo-1H-1,2,4-triazol-1-yl)carboxamidosulfonyl]-5-methylthiophene-3-carboxylate and its sodium salt, and also foramsulfuron and its sodium salt.

4. The solid water-dispersible formulation as claimed in claim 1 which comprises, as component (b), safeners from the group consisting of mefenpyrdiethyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide.

5. The solid water-dispersible formulation as claimed in claim 1 which comprises, as component (c), solvents from the group of the aromatic and aliphatic hydrocarbons.

6. The solid water-dispersible formulation as claimed in claim 1 which comprises, as component (d-1), carriers from the group of the natural tectosilicates.

7. The solid water-dispersible formulation as claimed in claim 1 which comprises, as component (d-2), carriers from the group consisting of the calcium silicates and precipitated silicic acids.

8. The solid water-dispersible formulation as claimed in claim 1, in which emulsifiers from the group of the formulations of salts of alkylated aromatic sulfonic acids with alkylated copolymers of ethylene oxide and propylene oxide are present as component (e-1).

9. The solid water-dispersible formulation as claimed in claim 1 which comprises, as component (e-2), antifoams from the group of the suspoemulsions of hydrophobicized silicic acid particles in aqueous emulsion concentrates based on liquid silicone surfactants and solid antifoams.

10. The solid water-dispersible formulation as claimed in claim 1 which comprises, as component (e-3), wetting agents from the group of the block copolymers of propylene oxide and ethylene oxide on ethylenediamine, the salts of the alkylated naphthalenesulfonic acids and the salts of dioctylsulfosuccinic acid.

11. The solid water-dispersible formulation as claimed in claim 1 which comprises, as component (e-4), dispersants from the group of the condensates of aromatic sulfonic acids with formaldehyde and salts thereof.

12. The solid water-dispersible formulation as claimed in claim 1, additionally comprising, as component (f), one or more herbicidally active compounds from the group of the carbamates, thiocarbamates, halogenacetanilides, substituted phenoxy-, naphthoxy- and phenoxyphenoxycarboxylic acid derivatives and also heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic esters, cyclohexanedione derivatives, phosphorus-containing herbicides of the glufosinate type or of the glyphosate type, S-(N-aryl-N-alkylcarbamoylmethyl)dithiophosphoric esters, and also sulfonamides and salts thereof which are not included in the scope of the formula (I) (component a), such as representatives from the group of the phenylsulfonylureas, such as iodosulfuron-. methyl and its sodium salt (iodosulfuron-methyl-sodium) and mesosulfuron-methyl and its sodium salt, and also representatives from the group of the other sulfonamides, such as amidosulfuron and its sodium salt (amidosulfuron-methyl-sodium).

13. The solid water-dispersible formulation as claimed in claim 1, additionally comprising, as component (g), one or more auxiliaries and additives different from component (e), from the group of the disintegrants, such as crosslinked polyvinylpyrrolidones, binders (tackifiers), such as polyvinylpyrrolidone types, and agents for adjusting the pH, such as NaOH and Na₂CO.

14. A process for preparing a solid water-dispersible formulation as claimed in claim 1 which comprises combining the individual components in the respective ratios defined by the preparation.

15. A method for controlling harmful plants, which comprises applying an effective amount of a solid water-dispersible formulation as claimed in claim 1 to the harmful plants, to parts of the plants, to plant seeds and/or to the area on which the plants grow.

16. Method of use for controlling harmful plants using a solid water-dispersible formulation as claimed in claim 1.

17. Method of use for preparing a herbicidal composition using a solid water-dispersible formulation as claimed in claim 1.

18. A herbicidal composition, comprising a solid water-dispersible formulation as claimed in claim 1.

19. A method for controlling harmful plants which comprises applying an effective amount of a herbicidal composition as claimed in claim 18 to the harmful plants, to parts of the plants, to plant seeds and/or to the area on which the plants grow.

20. Method of use for controlling harmful plants using a herbicidal composition as claimed in claim 18.
